(19) United States
(12) Patent Application Publication
(10) Pub. No.: US 2026/0135771 A1
(43) Pub. Date: May 14, 2026

(54) MODELS FOR ARTIFICIAL INTELLIGENCE IN WIRELESS COMMUNICATIONS SYSTEMS

(71) Applicant: Lenovo (United States) Inc., Morrisville, NC (US)

(72) Inventors: Vahid Pourahmadi, München (DE); Vijay Nangia, Woodridge, IL (US)

(73) Assignee: Lenovo (United States) Inc., Morrisville, NC (US)

(21) Appl. No.: 18/948,252

(22) Filed: Nov. 14, 2024

(51) Int. Cl. H04L 41/16; H04W 24/02

(52) U.S. Cl. CPC H04L 41/16; H04W 24/02

(57) ABSTRACT

Various aspects of the present disclosure relate to models for artificial intelligence in wireless communications systems. A first apparatus (e.g., user equipment (UE), network equipment (NE)) obtains one or more of a first neural network encoder model or a first neural network decoder model, and one or more first data sets associated with one or more of the first neural network encoder model or the first neural network decoder model. The first apparatus trains one or more of a second neural network encoder model or a second neural network decoder model based at least in part on: the one or more of the first neural network encoder model or the first neural network decoder model; and one or more second data sets, wherein the one or more second data sets are based at least in part on the one or more first data sets.

### TECHNICAL FIELD

The present disclosure relates to wireless communications, and more specifically to machine learning and artificial intelligence in wireless communications.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

A first apparatus (e.g., UE, NE) for wireless communication is described. The first apparatus may be configured to, capable of, or operable to perform one or more operations as described herein. For example, the first apparatus may be configured to, capable of, or operable to obtain a first neural network encoder model and a first data set associated with the first neural network encoder model; and communicate in accordance with a second neural network encoder model, where the second neural network encoder model is trained based at least in part on the first neural network encoder model and a second data set, and where the second data set is determined based at least in part on the first data set.

A processor (e.g., a standalone processor chipset, or a component of an apparatus such as a UE and/or NE) for wireless communication is described. The processor may be configured to, capable of, or operable to perform one or more operations as described herein. For example, the processor may be configured to, capable of, or operable to obtain a first neural network encoder model and a first data set associated with the first neural network encoder model; and communicate in accordance with a second neural network encoder model, where the second neural network encoder model is trained based at least in part on the first neural network encoder model and a second data set, and where the second data set is determined based at least in part on the first data set.

A method performed or performable by a first apparatus (e.g., a UE and/or NE) for wireless communication is described. The method may include obtaining a first neural network encoder model and a first data set associated with the first neural network encoder model; and communicating in accordance with a second neural network encoder model, where the second neural network encoder model is trained based at least in part on the first neural network encoder model and a second data set, and where the second data set is determined based at least in part on the first data set.

In some implementations of the first apparatus (e.g., UE, NE), the processor, and the method described herein, the first apparatus, the processor, and the method may further be configured to, capable of, operable to, performed to, or performable to input a data sample to the trained second neural network encoder model to generate an encoded data sample, where to communicate, the at least one processor is configured to cause the first apparatus to transmit the encoded data sample to a second apparatus.

In some implementations of the first apparatus (e.g., UE, NE), the processor, and the method described herein, the first apparatus, the processor, and the method may further be configured to, capable of, operable to, performed to, or performable to obtain the first neural network encoder model from a set of reference neural network encoder models; or retrieve the first neural network encoder model from a data storage.

In some implementations of the first apparatus (e.g., UE, NE), the processor, and the method described herein, the first apparatus, the processor, and the method may further be configured to, capable of, operable to, performed to, or performable to obtain the first neural network encoder model from a second apparatus; or obtain a parameter set for the first neural network encoder model from the second apparatus.

In some implementations of the first apparatus (e.g., UE, NE), the processor, and the method described herein, the first data set includes one or more of: a set of data samples used to train the first neural network encoder model; or a set of data samples that are within a threshold statistical similarity to a set of data samples used to train the first neural network encoder model.

In some implementations of the first apparatus (e.g., UE, NE), the processor, and the method described herein, the first apparatus, the processor, and the method may further be configured to, capable of, operable to, performed to, or performable to obtain the first data set from a set of reference training data sets; or retrieve the first data set from a data storage.

In some implementations of the first apparatus (e.g., UE, NE), the processor, and the method described herein, the first apparatus, the processor, and the method may further be configured to, capable of, operable to, performed to, or performable to obtain the first data set from a second apparatus.

In some implementations of the first apparatus (e.g., UE, NE), the processor, and the method described herein, the second data set is based at least in part on a local training data set that is local to the first apparatus, and where the local training data set includes one or more input data samples associated with one or more neural network encoder models.

In some implementations of the first apparatus (e.g., UE, NE), the processor, and the method described herein, the local training data set is based at least in part on reference signals received from a second apparatus.

In some implementations of the first apparatus (e.g., UE, NE), the processor, and the method described herein, the second data set is based at least in part on a local training data set that is received from a second apparatus.

In some implementations of the first apparatus (e.g., UE, NE), the processor, and the method described herein, the first apparatus, the processor, and the method may further be configured to, capable of, operable to, performed to, or performable to determine a first portion of the second data set from the first data set and a second portion of the second data set from the local training data set based at least in part on a statistical similarity between the first data set and the local training data set.

In some implementations of the first apparatus (e.g., UE, NE), the processor, and the method described herein, the first apparatus includes a UE or a NE.

A first apparatus (e.g., UE, NE) for wireless communication is described. The first apparatus may be configured to, capable of, or operable to perform one or more operations as described herein. For example, the first apparatus may be configured to, capable of, or operable to obtain a first neural network decoder model and a first data set associated with the first neural network decoder model; and communicate in accordance with a second neural network decoder model, where the second neural network decoder model is trained based at least in part on the first neural network decoder model and a second data set, and where the second data set is determined based at least in part on the first data set.

A processor (e.g., a standalone processor chipset, or a component of an apparatus such as a UE and/or NE) for wireless communication is described. The processor may be configured to, capable of, or operable to perform one or more operations as described herein. For example, the processor may be configured to, capable of, or operable to obtain a first neural network decoder model and a first data set associated with the first neural network decoder model; and communicate in accordance with a second neural network decoder model, where the second neural network decoder model is trained based at least in part on the first neural network decoder model and a second data set, and where the second data set is determined based at least in part on the first data set.

A method performed or performable by a first apparatus for wireless communication is described. The method may include obtaining a first neural network decoder model and a first data set associated with the first neural network decoder model; and communicating in accordance with a second neural network decoder model, where the second neural network decoder model is trained based at least in part on the first neural network decoder model and a second data set, and where the second data set is determined based at least in part on the first data set.

A first apparatus (e.g., UE, NE) for wireless communication is described. The first apparatus may be configured to, capable of, or operable to perform one or more operations as described herein. For example, the first apparatus may be configured to, capable of, or operable to obtain one or more of a first neural network encoder model or a first neural network decoder model, and one or more first data sets associated with one or more of the first neural network encoder model or the first neural network decoder model; and communicate in accordance with one or more of a second neural network encoder model or a second neural network decoder model, where the one or more of the second neural network encoder model or the second neural network decoder model are trained based at least in part on: the one or more of the first neural network encoder model or the first neural network decoder model; and one or more second data sets, where the one or more second data sets are determined based at least in part on the one or more first data sets.

A processor (e.g., a standalone processor chipset, or a component of an apparatus such as a UE and/or NE) for wireless communication is described. The processor may be configured to, capable of, or operable to perform one or more operations as described herein. For example, the processor may be configured to, capable of, or operable to obtain one or more of a first neural network encoder model or a first neural network decoder model, and one or more first data sets associated with one or more of the first neural network encoder model or the first neural network decoder model; and communicate in accordance with one or more of a second neural network encoder model or a second neural network decoder model, where the one or more of the second neural network encoder model or the second neural network decoder model are trained based at least in part on: the one or more of the first neural network encoder model or the first neural network decoder model; and one or more second data sets, where the one or more second data sets are determined based at least in part on the one or more first data sets.

A method performed or performable by a first apparatus for wireless communication is described. The method may include obtaining one or more of a first neural network encoder model or a first neural network decoder model, and one or more first data sets associated with one or more of the first neural network encoder model or the first neural network decoder model; and communicating in accordance with one or more of a second neural network encoder model or a second neural network decoder model, where the one or more of the second neural network encoder model or the second neural network decoder model are trained based at least in part on: the one or more of the first neural network encoder model or the first neural network decoder model; and one or more second data sets, where the one or more second data sets are determined based at least in part on the one or more first data sets.

In some implementations of the first apparatus (e.g., UE, NE), the processor, and the method described herein, the one or more of the first neural network encoder model, the first neural network decoder model, or the one or more first data sets are obtained from one or more of a set of reference neural network encoder models, a set of reference neural network decoder models, or a data storage.

In some implementations of the first apparatus (e.g., UE, NE), the processor, and the method described herein, the first apparatus, the processor, and the method may further be configured to, capable of, operable to, performed to, or performable to train the second neural network encoder model and the second neural network decoder model based at least in part on the first neural network encoder model, the first neural network decoder model, and the one or more second data sets.

In some implementations of the first apparatus (e.g., UE, NE), the processor, and the method described herein, the one or more first data sets are obtained from one or more of a second apparatus or a data storage, and the one or more second data sets are based at least in part on a local training data set that is local to the first apparatus, and where the local training data set includes one or more input data samples associated with one or more neural network encoder models.

In some implementations of the first apparatus (e.g., UE, NE), the processor, and the method described herein, the local training data set is based at least in part on reference signals received at the first apparatus from a second apparatus.

In some implementations of the first apparatus (e.g., UE, NE), the processor, and the method described herein, the first apparatus, the processor, and the method may further be configured to, capable of, operable to, performed to, or performable determine to a first portion of the one or more second data sets from the one or more first data sets and a second portion of one or more the second data sets from the local training data set based at least in part on a statistical similarity between the one or more first data sets and the local training data.

### BRIEF DESCRIPTION OF THE DRAWINGS

FIG. 1 illustrates an example of a wireless communications system in accordance with aspects of the present disclosure.

FIG. 2 illustrates a wireless network including a NE and multiple UEs.

FIG. 3 illustrates a high-level structure of a two-sided model.

FIG. 4 illustrates aperiodic trigger state defining a list of channel state information (CSI) report settings.

FIG. 5 illustrates at aperiodic trigger state indicating the resource set and quasi-co-location (QCL) information.

FIGS. 6 and 7 illustrate radio resource control (RRC) configuration for non-zero power CSI reference signal (NZP-CSI-RS) or CSI interference measurement (CSI-IM) resources.

FIG. 8 illustrates partial CSI omission for physical uplink shared channel (PUSCH)-Based CSI.

FIG. 9 illustrates an example of a UE in accordance with aspects of the present disclosure.

FIG. 10 illustrates an example of a processor in accordance with aspects of the present disclosure.

FIG. 11 illustrates an example of a NE in accordance with aspects of the present disclosure.

FIG. 12 illustrates a flowchart of a method in accordance with aspects of the present disclosure.

FIG. 13 illustrates a flowchart of a method in accordance with aspects of the present disclosure.

FIG. 14 illustrates a flowchart of a method in accordance with aspects of the present disclosure.

### DETAILED DESCRIPTION

In a wireless communications system, a UE and a NE (e.g., a base station, a next-generation NodeB (gNB)) may support wireless communication (e.g., reception and/or transmission of wireless communication) using time-frequency resources. Wireless communications systems can utilize artificial intelligence (AI) and machine learning (ML) (AI/ML, hereinafter referred to as “AI”) for a variety of different purposes, such as for network operation, network optimization, automated processing (e.g., self-driving cars in vehicle to everything (V2X) scenarios), network planning, security information and event management (SIEM)), etc. AI can leverage AI models (e.g., machine learning models or neural network models, which may be referred to herein as “models”) which represent programs and/or algorithms trained on a set of data to provide outputs, such as to recognize patterns, make decisions, generate content, etc. AI models, for instance, can apply different algorithms to data inputs to provide data output for performing different tasks.

AI models in wireless communications systems can be implemented in a variety of configurations. For instance, models can be implemented at a transmitter, a receiver, or both. For instance, a model can be trained and implemented at the UE side, NE side, or at both UE and NE sides. For example, a two sided model represents an AI model that includes AI functionality at both the UE and NE sides. Implementing a two sided model involves a number of challenges, such as identifying encoder-decoder pairs that enable cooperation between the UE and the NE. Additionally, such challenges include generating and maintaining training data that can maintain cooperative functionality between different sides of a two sided AI model. Different methods are available to train and update models of two-sided models (e.g., neural network (NN) modules of a two-sided model), including centralized training, simultaneous training, and separate training. Each of these approaches may involve different levels of inter-entity (e.g., inter-vendor) cooperation. Several schemes may be implemented to reduce the complexity of inter-entity collaboration but some of these schemes may result in performance degradation of resulting two-sided models.

Aspects of the present disclosure are described in the context of a wireless communications system, and include implementations that provide solutions to enable UEs and NEs to develop and/or implement encoder models and decoder models that are interoperable such that accurate data encoding and decoding can occur. This disclosure also describes different ways for providing reference models and reference training datasets. For instance, the described solutions enable UEs and NEs to obtain and/or exchange reference models and reference training data to enable matching (e.g., functional matching) between UE side and NE side models.

By performing the described techniques, devices in a wireless communications system can accurately and efficiently encode and decode data transmitted between the devices, which can enable more efficient and accurate information exchange. Examples of data that can be encoded, decoded, and exchanged (e.g., transmitted, received) between devices (e.g., UEs, NEs) include CSI, time-frequency resource information, connectivity information, etc.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

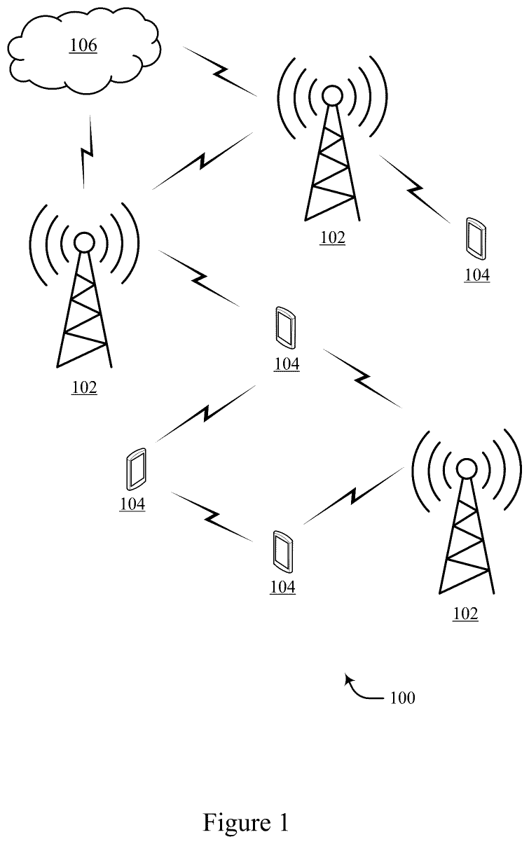

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, a network element, a network function, a network entity, a radio access network (RAN), a NodeB, an eNodeB (eNB), a gNB, or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHZ-24.25 GHZ), FR4 (52.6 GHz-114.25 GHZ), FR4a or FR4-1 (52.6 GHZ-71 GHZ), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, an apparatus (e.g., UE 104, NE 102) obtains one or more of a first neural network encoder model or a first neural network decoder model or both, and one or more first data sets associated with one or more of the first neural network encoder model or the first neural network decoder model. The apparatus trains one or more of a second neural network encoder model or a second neural network decoder model based at least in part on the one or more of the first neural network encoder model or the first neural network decoder model, and one or more second data sets, where the one or more second data sets are based at least in part on the one or more first data sets.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

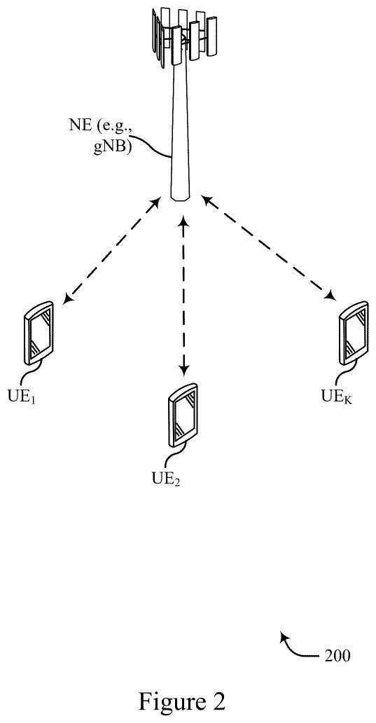

FIG. 2 illustrates a wireless network 200 including a NE and multiple UEs. The UEs, for instance, include a UE₁, UE₂, and UE_{K}. The NE (e.g., base station) can be represented as a node B₁ equipped with M antennas and the K UEs denoted by U₁, U₂, . . . , U_{K} with each having N antennas.

$${H}_{l}^{k} ( t )$$

can denote a channel at time t over a frequency band l, l∈{1, 2, . . . , L}, between B₁ and Uₖ which is a matrix of size N×M with complex entries, i.e.,

$${H}_{l}^{k} ( t ) ∈ {ℂ}^{N \times M} .$$

At time t and frequency band l, it can be assumed that the NE (e.g., base station) is to transmit a message

$${x}_{l}^{k} ( t )$$

to U_{K}, where K={1, 2, . . . , K} while the base station uses

$${w}_{l}^{k} ( t ) ∈ {ℂ}^{M \times 1}$$

as the precoding vector. The received signal at

$${U}_{k} , {y}_{l}^{k} ( t ) ,$$

can be indicated as:

$${y}_{l}^{k} ( t ) = {H}_{l}^{k} ( t ) {w}_{l}^{k} ( t ) {x}_{l}^{k} ( t ) + {n}_{l}^{k} ( t )$$

where

$${n}_{l}^{k} ( t )$$

represents the noise vector at the receiver.

To improve the achievable rate of the link, an NE can select

$${w}_{l}^{k} ( t )$$

that maximizes the received signal-to-noise ratio (SNR) or signal to interference plus noise ratio (SINR) (in case of muti-user transmission). Several schemes have been proposed for selection of

$${w}_{l}^{k} ( t )$$

where most of them relies on having some knowledge about

$${H}_{l}^{k} ( t )$$

at the node B₁. For instance, the NE can obtain knowledge of

$${H}_{l}^{k} ( t )$$

by direct measurement of the channel (e.g., in time division duplex (TDD) mode and assuming reciprocity of the channel), or indirectly using the information that the UE sends to the NE (e.g., in frequency division duplexing (FDD) mode). In the latter case, a large amount of feedback may be involved to send accurate information about

$${H}_{l}^{k} ( t ) .$$

This becomes particularly important if a large quantity of antennas or/and large frequency bands are involved.

For simplicity in description, a single time slot can be discussed, but it is to be understood that the proposed scheme can be further extended to the cases with more than a single time slot. Without loss of generality, therefore,

$${H}_{l}^{k} ( t )$$

can be denoted using

$${H}_{l}^{k} .$$

Further, H^{k} can be defined as matrix of size N×M×L which can be composed by stacking

$${H}_{l}^{k}$$

for all frequency bands, e.g., the entries at H^{k}[n, m, l] are equal to

$${H}_{l}^{k} [ n , m ] .$$

Therefore, sending complete information regarding H^{k}, the UE may feedback the information about N×M×L complex numbers to the gNB.

Several methods have been proposed trying to reduce the rate of required feedback. A first group of methods includes conventional methods which are based on quantization of the measured channel based on a codebook designed in 3^{rd} Generation Partnership Project (3GPP). Another group of methods (e.g., AI-based methods) include two-sided models with two parts where the first part is deployed at the UE side and the second part is deployed at the NE side. The UE and NE sides may include one or a few neural network blocks which are trained using data driven approaches. The UE side (e.g., the encoder part) can compute a latent representation of the input data (e.g., what is transferred to the NE) with as low number of bits as possible. A latent representation, for instance, represents encoded data that is generated by an encoder from input data, such as encoded CSI, encoded time-resource information, encoded connectivity information, etc. Receiving what has been transmitted by the UE side, the NE side (e.g., the decoder part) reconstructs the information intended to be transmitted to the NE using the received message.

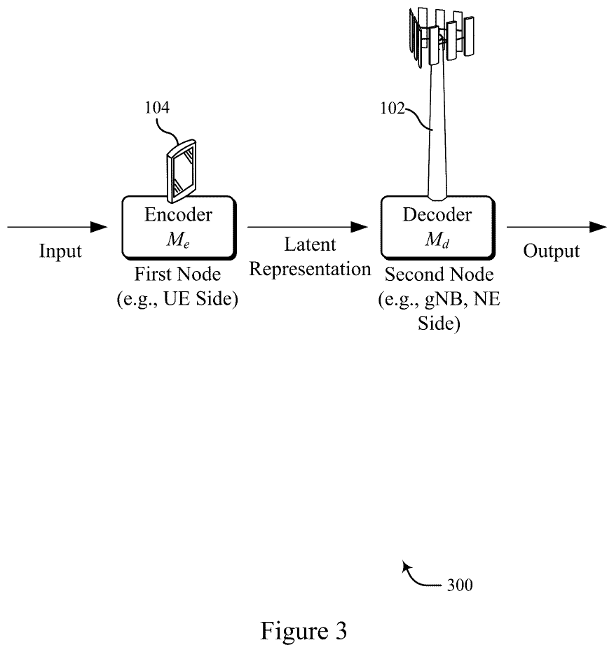

FIG. 3 illustrates a high-level structure of a two-sided model 300. The two-sided model 300 includes a neural network-based UE 104 side and a NE 102 side referred to here as Mₑ (encoding model) and M_{d} (decoding model), respectively. The input of the model is based on channel measurement, can be for example be raw channel measurement, or eigenvectors associated to the measured channel. For instance, the UE 104 may perform a channel measurement to identify one or more measurement parameters. The UE 104 may use such measurement parameters as an input to the encoding model Mₑ. The structure of the UE side and NE side can vary depending on the particular scheme but it can be assumed that the encoder includes of a few layers and the output is (or can be converted to) a vector z with a certain size, e.g., d. It is to be noted that as the encoder and the decoder model are to be trained together so the decoder be aware of how the encoder transformed the input data to the latent domain in other that it can produce the output from a latent representation. Also, it is to be noted that in some use cases (e.g., in case of CSI feedback) the input and output are the same, e.g., the UE 104 may reconstruct the input data from the latent representation.

The UE 104 (e.g., the first node) and the NE 102 (e.g., the second node) may implement several methods to train the neural network modules of a two-sided model, including centralized training, simultaneous training, and separate training. Similarly, updating a two-sided model can be carried out centrally on one entity, on different entities simultaneously, or separately. Each of these approaches involves different level of inter-vendor collaborations. For example, in separate training/model update, the neural network modules of the first node (e.g., UE) and the second node (e.g., NE) are trained in different training sessions but are to be trained sequentially. For example, after the NE trained the decoder model, the NE is to send some information (e.g., a dataset) to the UE so the UE can train the encoder model. Such dependency and communication between the NE and UE can increase the complexity of inter-vendor collaboration.

Different directions have been proposed for reducing the complexity of inter-vendor collaboration. Direction A assumes that the NE side trains the decoder model and shares information about the decoder or a matching encoder with UE vendors that are to design the encoder. The UE vendor can then train the encoder model based on the received information from the NE side. Direction A involves some level of collaboration between then UE and the NE, and also involves some offline engineering for development of the UE-side encoder model. In Direction B, the NE side trains the decoder model and also the encoder model and then shares information about the encoder model with UEs that determine to connect to the NE. The UE can then use the encoder model (with possibly some optimization) directly as its encoder model. The complexity of this method is a bit less than Direction A since it may not involve offline engineering. However, there are some performance concerns as there may not be ways for the UE to adapt the encoder to its own inference data input statistics, if needed.

In Direction C, instead of having the UE and NE vendors design their own decoders/encoders, one entity (e.g., 3GPP) can design one or more reference encoder models and/or one or more reference decoder models based on one or more datasets, and the entity may specify the designed models. A NE or UE vendor can then use such specified model as their decoder/encoder, and/or can develop or optimize their own decoder/encoder. The complexity of inter-vendor collaboration in this direction may be less than that of the other discussed options. However, there may be some concerns on applicability and performance of the trained model in the field as the dataset used for training (e.g., based on a statistical channel model) may have different statistics compared to the data collected during the inference phase in the field.

There are some schemes for compressing the channel information before sending channel information (e.g., CSI) to a NE. In some schemes, a number of feedback bits can be different for different measurements, such as by skipping transmission of some of the entries which have small values. A summary is provided herein, namely on how to define the CSI Codebooks and then how to feedback the resulted bits.

For NR Release 15 Type-II codebook, it may be assumed that an NE is equipped with a two-dimensional (2D) antenna array with N₁, N₂ antenna ports per polarization placed horizontally and vertically and communication occurs over N₃ precoding matrix indicator (PMI) sub-bands. A PMI subband may include a set of resource blocks, each resource block including a set of subcarriers. In such cases, 2N₁N₂ CSI-reference signal (RS) (CSI-RS) ports are utilized to enable downlink (DL) channel estimation with high resolution for NR Rel. 15 Type-II codebook. In order to reduce the uplink (UL) feedback overhead, a Discrete Fourier transform (DFT)-based CSI compression of the spatial domain is applied to L dimensions per polarization, where L<N₁N₂. In the sequel the indices of the 2L dimensions are referred as the spatial domain (SD) basis indices.

The amplitude and phase values of the linear combination coefficients for each sub-band are fed back to the gNB as part of the CSI report. The 2N₁N₂×N₃ codebook per layer/takes on the form

$${W}_{l} = {W}_{1} {W}_{2 , l} ,$$

where W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and B is an N₁N₂×L matrix with columns drawn from a 2D oversampled DFT matrix, as follows

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] ,$$

$${v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T} ,$$

$$B = [ \begin{matrix}{v}_{{l}_{0} , {m}_{0}} & {v}_{{l}_{1} , {m}_{1}} & … & {v}_{{l}_{L - 1} , {m}_{L - 1}}\end{matrix} ] ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} ,$$

where the superscript ^{T} denotes a matrix transposition operation. O₁, O₂ oversampling factors may be assumed for the 2D DFT matrix from which matrix B is drawn. W₁ may be common across all layers. W_{2,l} is a 2L×N₃ matrix, where the i^{th} column corresponds to the linear combination coefficients of the 2L beams in the i^{th} sub-band. The indices of the L selected columns of B are reported, along with the oversampling index taking on O₁O₂ values. W_{2,l} may be independent for different layers.

For NR Release 15 Type-II codebook, K (where K≤2N₁N₂) beamformed CSI-RS ports are utilized in DL transmission in order to reduce complexity. The. The K×N₃ codebook matrix per layer takes on the form

$${W}_{l} = {W}_{1}^{PS} {W}_{2 , l} .$$

Here, W₂ follow the same structure as the conventional NR Rel. 15 Type-II Codebook, and are layer specific.

$${W}_{1}^{PS}$$

is a K×2L block-diagonal matrix with two identical diagonal blocks, e.g.,

$${W}_{1}^{PS} = [ \begin{matrix}E & 0 \\ 0 & E\end{matrix} ] ,$$

### and E is an

$$\frac{K}{2} \times L$$

matrix whose columns are standard unit vectors, as follows.

$$E = [ {e}_{mod ( {m}_{PS} {d}_{PS} , K / 2 )}^{( K / 2 )} {e}_{mod ( {m}_{PS} {d}_{PS} + 1 , K / 2 )}^{( K / 2 )} … {e}_{mod ( {m}_{PS} {d}_{PS} + L - 1 , K / 2 )}^{( K / 2 )} ] ,$$

where

$${e}_{i}^{( K )}$$

is a standard unit vector with a 1 at the i^{th} location. Here d_{PS} is a radio resource control (RRC) parameter which takes on the values {1,2,3,4} under the condition d_{PS}≤min(K/2, L), whereas m_{PS} takes on the values

$$\{ 0 , … , ⌈ \frac{K}{2 {d}_{PS}} ⌉ - 1 \}$$

and is reported as part of the UL CSI feedback overhead. W₁ is common across all layers.

For K=16, L=4 and d_{PS}=1, the 8 possible realizations of E corresponding to m_{PS}={0, 1, . . . , 7} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] , [ \begin{matrix}0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0\end{matrix} ] .$$

When d_{PS}=2, the 4 possible realizations of E corresponding to m_{PS}={0,1,2,3} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=3, the 3 possible realizations of E corresponding of m_{PS}={0,1,2} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=4, the 2 possible realizations of E corresponding of m_{PS}={0,1} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] .$$

To summarize, m_{PS} parametrizes the location of the first 1 in the first column of E, whereas d_{PS} represents the row shift corresponding to different values of m_{PS}.

NR Release 15 Type-I codebook is the baseline codebook for NR, with a variety of configurations. The most common utility of Rel. 15 Type-I codebook is a special case of NR Rel. 15 Type-II codebook with L=1 for rank indicator (RI)=1, 2, where a phase coupling value is reported for each sub-band (i.e., W_{2,l} is 2×N₃) with the first row equal to [1, 1, . . . , 1] and the second row equal to [e^{j2πØ}^{₀}, . . . , e^{j2πØ}^{_{N3-1}}]. Under specific configurations, φ₀=φ₁= . . . =φ_{N}_{₃}₋₁, e.g., wideband reporting. For RI>2 different beams are used for each pair of layers. NR Rel. 15 Type-I codebook can be depicted as a low-resolution version of NR Rel. 15 Type-II codebook with spatial beam selection per layer-pair and phase combining only.

For NR Release 16 Type-II codebook, assume the NE is equipped with a two-dimensional (2D) antenna array with N₁, N₂ antenna ports per polarization placed horizontally and vertically and communication occurs over N₃ PMI subbands. A PMI subband includes of a set of resource blocks, each resource block including of a set of subcarriers. In such case, 2N₁N₂N₃ CSI-RS ports are utilized to enable DL channel estimation with high resolution for NR Rel. 16 Type-II codebook. To reduce the UL feedback overhead, a DFT-based CSI compression of the spatial domain is applied to L dimensions per polarization, where L<N/N₂. Similarly, additional compression in the frequency domain is applied, where each beam of the frequency-domain precoding vectors is transformed using an inverse DFT matrix to the delay domain, and the amplitude and phase values of a subset of the delay-domain coefficients are selected and fed back to the gNB as part of the CSI report. The 2N₁N₂×N₃ codebook per layer takes on the form:

$${W}_{l} = {W}_{1} {\tilde{W}}_{2 , l} {W}_{f , l}^{H} ,$$

where W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and B is an N₁N₂×L matrix with columns drawn from a 2D oversampled DFT matrix, as follows.

$${u}_{m} = [ 1 {e}^{j \frac{2 π m}{{O}_{2} {N}_{2}}} … {e}^{j \frac{2 π m ( {N}_{2} - 1 )}{{O}_{2} {N}_{2}}} ] ,$$

$${v}_{l , m} = {[ {u}_{m} {e}^{j \frac{2 π l}{{O}_{1} {N}_{1}}} {u}_{m} … {e}^{j \frac{2 π l ( {N}_{1} - 1 )}{{O}_{1} {N}_{1}}} {u}_{m} ]}^{T} ,$$

$$B = [ {v}_{{l}_{0} , {m}_{0}} {v}_{{l}_{1} , {m}_{1}} … {v}_{{l}_{L - 1} , {m}_{L - 1}} ] ,$$

$${l}_{i} = {O}_{1} {n}_{1}^{( i )} + {q}_{1} , 0 \leq {n}_{1}^{( i )} < {N}_{1} , 0 \leq {q}_{1} \leq {O}_{1 ,}$$

$${m}_{i} = {O}_{2} {n}_{2}^{( i )} + {q}_{2} , 0 \leq {n}_{2}^{( i )} < {N}_{2} , 0 \leq {q}_{2} \leq {O}_{2 ,}$$

where the superscript ^{T} denotes a matrix transposition operation. O₁, O₂ oversampling factors are assumed for the 2D DFT matrix from which matrix B is drawn. W₁ is common across all layers. W_{f,l} is an N₃×M matrix (M<N₃) with columns selected from a critically sampled size-N₃ DFT matrix, as follows:

$${W}_{f , l} = [ {f}_{{k}_{0}} {f}_{{k}_{1}} … {f}_{{k}_{M - 1}} ] , 0 \leq {k}_{i} \leq {N}_{3} - 1 ,$$

$${f}_{k} = {[ 1 {e}^{- j \frac{2 πk}{{N}_{3}}} … {e}^{- j \frac{2 πk ( {N}_{3} - 1 )}{{N}_{3}}} ]}^{T} .$$

The indices of the L selected columns of B are reported, along with the oversampling index taking on O₁O₂ values. Similarly, for W_{f,l}, only the indices of the M selected columns out of the predefined size-N₃ DFT matrix are reported. In the sequel the indices of the M dimensions are referred as the selected frequency domain (FD) basis indices. Hence, L, M represent the equivalent spatial and frequency dimensions after compression, respectively. Finally, the 2L×M matrix \tilde{W}₂ represents the linear combination coefficients (LCCs) of the spatial and frequency DFT-basis vectors. Both \tilde{W}₂, and W_{f,l} are selected independently for different layers. Amplitude and phase values of an approximately β fraction of the 2 LM available coefficients are reported to the gNB (β<1) as part of the CSI report.

In some examples, coefficients with zero amplitude values are indicated via a layer-specific bitmap matrix Sₗ of size 2L×M, where each bit of the bitmap matrix Sₗ indicates whether a coefficient has a zero-amplitude value, where for these coefficients no quantized amplitude and phase values are to be reported. Since all non-zero coefficients reported within a layer are normalized with respect to the coefficient with the largest amplitude value (strongest coefficient), where the amplitude and phase values corresponding to the strongest coefficient are set to one and zero, respectively, and hence no further amplitude and phase information is explicitly reported for this coefficient, and only an indication of the index of the strongest coefficient per layer is reported. Hence, for a single-layer transmission, amplitude, and phase values of a maximum of [2βLM]−1 coefficients (along with the indices of selected L, M DFT vectors) are reported per layer, leading to significant reduction in CSI report size, compared with reporting 2N₁N₂×N₃−1 coefficients' information.

For NR Release 16 Type-II port selection codebook, only K (where K≤2N₁N₂) beamformed CSI-RS ports are utilized in DL transmission, in order to reduce complexity. The. The K×N₃ codebook matrix per layer takes on the form:

$${W}_{l} = {W}_{1}^{PS} {\tilde{W}}_{2 , l} {W}_{f , l}^{H} .$$

Here, \tilde{W}_{2,l} and W_{f,l} follow the same structure as the conventional NR Rel. 16 Type-II Codebook, where both are layer specific. The matrix

$${W}_{1}^{PS}$$

is a K×2L block-diagonal matrix with the same structure as that in the NR Rel. 15 Type-II Port Selection Codebook.

NR Release 17 Type-II port selection codebook follows a similar structure as that of Rel. 15 and Rel. 16 port-selection codebooks, as follows:

$${W}_{l} = {\overline{W}}_{1}^{PS} {\tilde{W}}_{2 , l} {W}_{f , l}^{H} .$$

However, unlike Rel. 15 and Rel. 16 Type-II port-selection codebooks, the port-selection matrix

$${\overline{W}}_{1}^{PS}$$

supports free selection of the K ports, or more precisely the K/2 ports per polarization out of the N₁N₂ CSI-RS ports per polarization, i.e.,

$$⌈ {log}_{2} ( \begin{matrix}{N}_{1} {N}_{2} \\ K / 2\end{matrix} ) ⌉$$

bits are used to identify the K/2 selected ports per polarization, where this selection is common across all layers. Here, \tilde{W}_{2,l} and W_{f,l} follow the same structure as the conventional NR Rel. 16 Type-II Codebook, however M is limited to 1,2 only, with the network configuring a window of size N={2,4} for M=2. Moreover, the bitmap is reported unless β=1 and the UE reports all the coefficients for a rank up to a value of two.

In NR Release 18 Type II codebook the time-domain corresponding to slots is further compressed via DFT-based transformation, where the codebook is in the following form:

$${W}_{l} = {W}_{1} {{\tilde{W}}_{2 , l} ( {W}_{f , l} ⊗ {W}_{d , l} )}^{H} ,$$

where W₁, W_{f,l} follow the same structure as Rel-16 Type-II codebook, W_{d,l} is an N₄×Q matrix (Q≤N₄) with columns selected from a critically sampled size-N₄ DFT matrix, as follows:

$${W}_{d , l} = [ \begin{matrix}{d}_{{q}_{0}} & {d}_{{q}_{1}} & ⋯ & {d}_{{q}_{Q - 1}}\end{matrix} ] , \qquad 0 \leq {q}_{i} \leq {N}_{4} - 1 ,$$

$${d}_{q} = {[ \begin{matrix}1 & {e}^{- j \frac{2 π q}{{N}_{4}}} & … & {e}^{- j \frac{2 π q ( {N}_{4} - 1 )}{{N}_{4}}}\end{matrix} ]}^{T} .$$

The indices of the Q selected columns of W_{d,l} are reported. W_{d,l} may be layer specific, e.g., W_{d,1}≠W_{d,2}, or layer common, i.e., W_{d,1}= . . . =W_{d,RI}, where RI corresponds to the total number of layers, and the operator ⊗ corresponds to a Kronecker matrix product. Here, \tilde{W}_{2,l} is a 2L×MQ sized matrix with layer-specific entries representing the LCCs corresponding to the spatial-domain, frequency-domain and time-domain DFT-basis vectors. Thereby, a size 2L×MQ bitmap may be reported associated with Rel-18 Type-II codebook.

For codebook reporting, the codebook report can be partitioned into two parts based on the priority of information reported. Each part can be encoded separately (Part 1 has a possibly lower code rate). Below is a list the parameters for NR Rel. 16 Type-II codebook.

Content of CSI report: Part 1: RI+channel quality indicator (CQI)+Total number of coefficients. Part 2: SD basis indicator+FD basis indicator/layer+Bitmap/layer+Coefficient Amplitude info/layer+Coefficient Phase info/layer+Strongest coefficient indicator/layer. Furthermore, Part 2 CSI can be decomposed into sub-parts each with different priority (higher priority information listed first). Such partitioning can allow dynamic reporting size for codebook based on available resources in the uplink phase. Also, Type-II codebook is based on aperiodic CSI reporting, and only reported in physical uplink shared channel (PUSCH) via downlink control information (DCI) triggering (one exception). Type-I codebook can be based on periodic CSI reporting (physical uplink control channel (PUCCH)) or semi-persistent CSI reporting (PUSCH or PUCCH) or aperiodic reporting (PUSCH).

For priority reporting for Part 2 CSI, a transmitter (e.g., UE) may transmit multiple CSI reports with different priorities, as shown in Table 1 below. Additionally, the priority of the N_{Rep} CSI reports can be based on the following: (1) A CSI report corresponding to one CSI reporting configuration for one cell may have higher priority compared with another CSI report corresponding to one other CSI reporting configuration for the same cell; (2) CSI reports intended to one cell may have higher priority compared with other CSI reports intended to another cell; (3) CSI reports may have higher priority based on the CSI report content, e.g., CSI reports carrying layer 1 reference signal received power (L1-RSRP) information have higher priority; (4) CSI reports may have higher priority based on their type, e.g., whether the CSI report is aperiodic, semi-persistent or periodic, and whether the report is sent via PUSCH or PUCCH, may impact the priority of the CSI report.

CSI reports may be prioritized as follows, where CSI reports with lower identifiers (IDs) have higher priority.

$${Pri}_{iCSI} ( y , k , c , s ) = 2 \cdot {N}_{cells} \cdot {M}_{s} \cdot y + {N}_{cells} \cdot {M}_{s} \cdot k + {M}_{s} \cdot c + s$$

s: CSI reporting configuration index, and Ms: Maximum number of CSI reporting configurations
c: Cell index, and N_{cells}: Number of serving cells
k: 0 for CSI reports carrying L1-RSRP or L1-SINR, 1 otherwise
y: 0 for aperiodic reports, 1 for semi-persistent reports on PUSCH, 2 for semi-persistent reports on PUCCH, 3 for periodic reports.

TABLE 1
Priority Reporting Levels for Part 2 CSI

Priority 0:
For CSI reports 1 to N_{Rep}, Group 0 CSI for CSI
reports configured as ‘typeII-r16’ or ‘typeII-
PortSelection-r16’; Part 2 wideband CSI for CSI
reports configured otherwise
Priority 1:
Group 1 CSI for CSI report 1, if configured as
‘typeII-r16’ or ‘typeII-PortSelection-r16’; Part 2
subband CSI of even subbands for CSI report 1, if
configured otherwise
Priority 2:
Group 2 CSI for CSI report 1, if configured as
‘typeII-r16’ or ‘typeII-PortSelection-r16’; Part 2
subband CSI of odd subbands for CSI report 1, if
configured otherwise
Priority 3:
Group 1 CSI for CSI report 2, if configured as
‘typeII-r16’ or ‘typeII-PortSelection-r16’; Part 2
subband CSI of even subbands for CSI report 2, if
configured otherwise
Priority 4:
Group 2 CSI for CSI report 2, if configured as
‘typeII-r16’ or ‘typeII-PortSelection-r16’. Part 2
subband CSI of odd subbands for CSI report 2, if
configured otherwise
.
.
.
Priority 2N_{Rep} − 1:
Group 1 CSI for CSI report N_{Rep}, if configured as
‘typeII-r16’ or ‘typeII-PortSelection-r16’; Part 2
subband CSI of even subbands for CSI report N_{Rep},
if configured otherwise
Priority 2N_{Rep}:
Group 2 CSI for CSI report N_{Rep}, if configured as
‘typeII-r16’ or ‘typeII-PortSelection-r16’; Part 2
subband CSI of odd subbands for CSI report N_{Rep}, if
configured otherwise

Regarding triggering aperiodic CSI reporting on PUSCH, a UE reports CSI information for the network using the CSI framework in NR Release 15. A triggering mechanism between a report setting and a resource setting can be summarized as specified in Table 2.

TABLE 2
Triggering mechanism between a report
setting and a resource setting

| | | | Semi- | Access |
|---|---|---|---|---|
| | | Periodic | persistent | Point |
| | | CSI | (SP) CSI | (AP) CSI |
| | | reporting | reporting | Reporting |
| Time | Periodic | RRC | Medium access | DCI |
| Domain | CSI-RS | configured | control (MAC) | |
| Behavior | | | control element | |
| of | | | (CE) | |
| Resource | | | (PUCCH) | |
| Setting | | | DCI (PUSCH) | |
| | SP CSI- | Not Supported | MAC CE | DCI |
| | RS | | (PUCCH) | |
| | | | DCI (PUSCH) | |
| | AP CSI- | Not Supported | Not Supported | DCI |
| | RS | | | |

Moreover, all associated Resource Settings for a CSI Report Setting can have same time domain behavior. Periodic CSI-RS/interference measurement (IM) resource and CSI reports can be assumed to be present and active once configured by RRC. Aperiodic and semi-persistent CSI-RS/IM resources and CSI reports are to be explicitly triggered or activated. Aperiodic CSI-RS/IM resources and aperiodic CSI reports, the triggering is done jointly by transmitting a DCI Format 0-1. Semi-persistent CSI-RS/IM resources and semi-persistent CSI reports are independently activated.

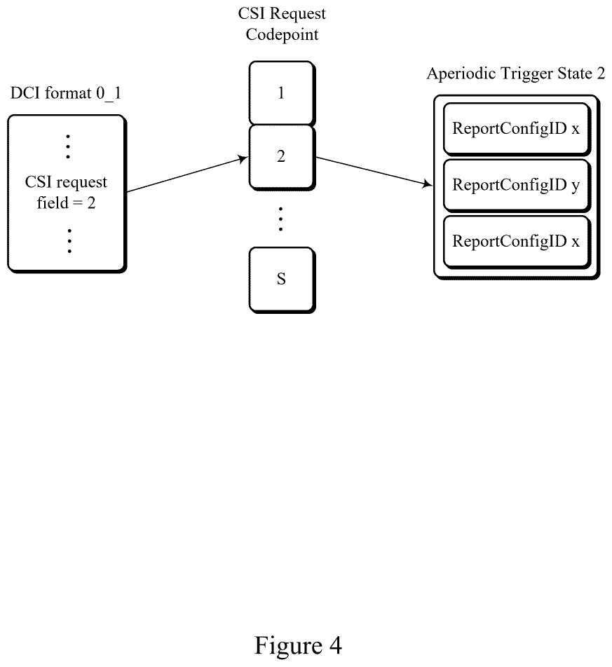

FIG. 4 illustrates aperiodic trigger state defining a list of CSI report settings. For aperiodic CSI-RS/IM resources and aperiodic CSI reports, the triggering is done jointly by transmitting a DCI Format 0_1. The DCI Format 0_1 includes a CSI request field (0 to 6 bits). A non-zero request field points to an aperiodic trigger state configured by RRC. An aperiodic trigger state in turn is defined as a list of up to 16 aperiodic CSI Report Settings, identified by a CSI Report Setting ID for which the UE calculates simultaneously CSI and transmits it on the scheduled PUSCH transmission.

When the CSI Report Setting is linked with aperiodic Resource Setting (which can include multiple Resource Sets), the aperiodic non-zero power (NZP) CSI-RS Resource Set for channel measurement, the aperiodic CSI-IM Resource Set (if used) and the aperiodic NZP CSI-RS Resource Set for IM (if used) to use for a given CSI Report Setting are also included in the aperiodic trigger state definition. For aperiodic NZP CSI-RS, the quasi-co-location (QCL) source to use is also configured in the aperiodic trigger state. The UE assumes that the resources used for the computation of the channel and interference can be processed with the same spatial filter e.g. quasi-co-located with respect to “QCL-TypeD.”

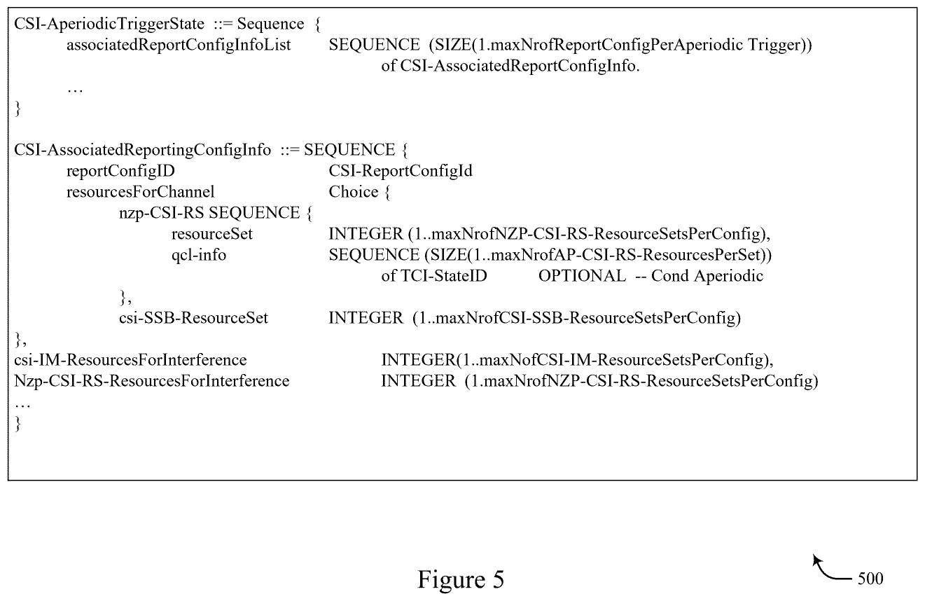

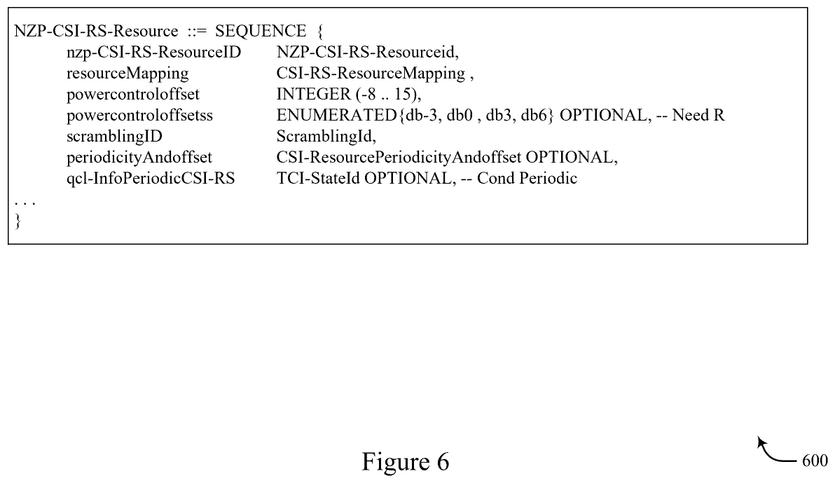

FIG. 5 illustrates at 500 aperiodic trigger state indicating the resource set and QCL information. FIGS. 6 and 7 illustrate RRC configuration for NZP-CSI-RS/CSI-IM resources. For instance, 600 illustrates RRC configuration for NZP-CSI-RS Resource and 700 illustrates RRC configuration for CSI-IM-Resource.

Table 3 summarizes the type of uplink channels used for CSI reporting as a function of the CSI codebook type.

TABLE 3
Uplink channels used for CSI reporting
as a function of the CSI codebook type

| | Periodic CSI | | AP CSI |
|---|---|---|---|
| | reporting | SP CSI reporting | reporting |
| Type I wide-band | PUCCH | PUCCH Format 2 | PUSCH |
| (WB) | Format 2, 3, 4 | PUSCH | |
| Type I sub-band | | PUCCH Format 3, 4 | PUSCH |
| (SB) | | PUSCH | |
| Type II WB | | PUCCH Format 3, 4 | PUSCH |
| | | PUSCH | |
| Type II SB | | PUSCH | PUSCH |
| Type II Part 1 only | | PUCCH Format 3, 4 | |

For aperiodic CSI reporting, PUSCH-based reports are divided into two CSI parts: CSI Part1 and CSI Part 2. For instance, the size of CSI payload varies significantly, and therefore a worst-case uplink control information (UCI) payload size design would result in large overhead. CSI Part 1 has a fixed payload size (and can be decoded by the NE without prior information) and contains the following: RI (if reported), CSI-RS resource indicator (CRI) (if reported) and CQI for the first codeword; number of non-zero wideband amplitude coefficients per layer for Type II CSI feedback on PUSCH.

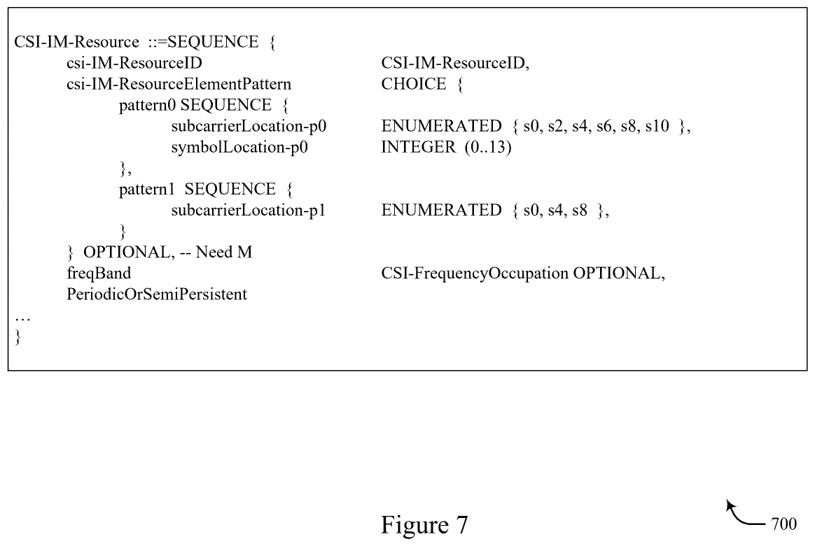

FIG. 8 illustrates at 800 partial CSI omission for PUSCH-Based CSI. CSI Part 2 has a variable payload size that can be derived from the CSI parameters in CSI Part 1 and contains PMI and the CQI for the second codeword when RI>4. For example, if the aperiodic trigger state indicated by DCI format 0_1 defines 3 report settings x, y, and z, then the aperiodic CSI reporting for CSI part 2 will be ordered as indicated in FIG. 8.

As discussed herein, CSI reports can be prioritized according to: (1) time-domain behavior and physical channel, where more dynamic reports are given precedence over less dynamic reports and PUSCH has precedence over PUCCH; (2) CSI content, where beam reports (e.g., L1-RSRP reporting) has priority over regular CSI reports; (3) the serving cell to which the CSI corresponds (in case of carrier aggregation (CA) operation). CSI corresponding to the primary cell (PCell) has priority over CSI corresponding to secondary cells (Scells); (4) a parameter (e.g., reportConfigID).

As discussed herein, different directions are considered for reducing the complexity of inter-vendor collaboration in developing encoders and/or decoders. Considering Direction C, some alternatives are considered. For instance, a reference encoder can be specified and designed. In such schemes, the NE side can assume that the encoders of the UEs are similar (e.g., compatible) with a reference encoder, and the NE side can design/develop its own decoder based on the reference encoder and a generated dataset, e.g., a dataset collected from an environment. The UE side can have several options including Option 1a and Option 2a.

Option 1a is to deploy a reference encoder (e.g., with possible minimal modification e.g., different model weights/parameters quantization) as the UE encoder. This option may experience degradation as the statistics (distribution) of the input (inference) data at the UE-side might be different from what have been used during the training phase of the reference encoder and so the encoder model may have difficulty determining an accurate latent representation of the current input data. Option 2a is for the UE side to use the reference encoder to design/develop its own encoder additionally based on current input data. The developed encoder in this case may have different behaviors compared to the reference encoder since the developed encoder may attempt to match the reference encoder to input samples collected at the UE side which potentially may result in a mismatch with the statistics of samples of the training dataset of the reference encoder. This difference in encoders may cause performance degradation as the NE side decoder may be designed to match the reference encoder and not the encoder developed at the UE side.

Further considering Direction C, another option is to design and specify a reference decoder. In such options the UE side can assume that the decoder of the NE is similar (e.g., compatible) with the reference decoder, and the UE can design/develop its own encoder based on the reference decoder and a dataset the UE collects from the environment. This NE side has several options including Option 1b and Option 2b. Option 1b is to deploy a reference decoder (e.g., with possible minimal modification e.g., different model weights/parameters quantization) as the NE own decoder. This option may limit the NE side from designing a more advanced decoder model compared to the reference decoder as NE is using the reference decoder. This may also limit the possibility of having the localized models (e.g., cell/site specific models). Option 2b is that the NE uses the reference decoder to design/develop its own decoder where the NE can also incorporate the information regarding a current dataset the NE has collected. The developed decoder in this case potentially could have different behavior compared to the reference decoder since the developed decoder tries to match the reference decoder on samples available at the NE side which potentially could have a mismatch with the statistics of samples of the training dataset of the reference decoder. This difference in decoders may cause performance degradation as the UE side encoder may be designed to match the reference decoder and not the NE side developed decoder.

Further considering Direction C, another option is to design and specify a reference encoder and a reference decoder. Several options are available, including Option 1c and Option 2c. In Option 1c the UE and the NE can use/deploy a reference encoder and reference decoder. Although in this case there may be no mismatch issue between the encoder and decoder, some performance degradation may occur due to difference between the statistics of the input data during inference and the training data used during the training phase of the reference encoder and the reference decoder. In Option 2c, the UE side can assume that the decoder of the NE is similar (compatible) with the reference decoder, and the UE can design/develop its own encoder based on the reference decoder and a dataset that the UE can collect from the environment. Furthermore, the NE side can assume that the encoders of the UEs are similar (compatible) with the reference encoder, and the NE can design/develop its own decoder based on the reference encoder and a dataset that the NE can collect from the environment. Although in Option 2c the UE side and the NE side can adapt their respective models based on their respective datasets, possible differences in the statistics of the UE side and NE side datasets may cause mismatch between the developed encoder and decoder models.

Considering the Direction B, if the UE determines that a received encoder is not working properly for the current input data statistics/distribution, the UE can initiate a model update process. For this update, the UE can develop its own encoder based on the received encoder and the input samples that the UE collects. This updated encoder may face some performance degradation since the decoder at the NE side has not observed the UE side input samples (with new statistics) and thus the NE side decoder may not work appropriately for the data encoded by the updated encoder at the UE side.

Aspects of the present disclosure include solutions for models for artificial intelligence in wireless communications systems. For instance, considering Direction C, training dataset D_{T}={(xᵢ, yᵢ), i={1, 2, . . . , N_{T}}} can be used to train the reference encoder,

$${M}_{e}^{R} ,$$

and reference decoder,

$${M}_{d}^{R} .$$

In D_{T} and following datasets, yᵢ can be equal to xᵢ. A few options are discussed below, including Option 1d, Option 2d, and Option 3d.

In Option 1d, the reference encoder,

$${M}_{e}^{R}$$

can be specified, e.g., in a standard specification. As discussed herein, a “specification” and/or “standard specification” can include a technical specification pertaining to wireless communication and/or AI. One example specification is a 3GPP technical specification (TS). During inference, the NE side can have access to another dataset D_{NW}={(xᵢ, yᵢ), i={1, 2, . . . , N_{NW}}} and the UE side can have access to another dataset D_{UE}={(xᵢ, yᵢ), i={1, 2, . . . , N_{UE}}} e.g., field data collection, model performance monitoring data, etc. As

$${M}_{e}^{R}$$

specified in the standard specification, NE can develop the decoder model M_{d} in several ways. For instance, the decoder model can be developed based on D_{NW} and assuming that the UE encoder will perform similar (compatible) to

$${M}_{e}^{R} .$$

Alternatively, or additionally, during the standardization process and at least for some reference encoder models, the reference encoder model can be linked/associated to a training dataset D_{T} that is used for training the reference encoder in a specification. The linked/associated dataset, i.e., D_{T}, might be part of the actual training dataset or a dataset with samples having similar statistics of the actual training dataset, or combination of them. This training dataset can be specified in the specification or can be stored in a storage. The training dataset may become publicly accessible (e.g., to the NE vendors and UE vendors) at a data storage location. To train M_{d}, NE can use D_{T}. For example, NE can consider a two-sided model of

$$( {M}_{e}^{R} , {M}_{d} )$$

and train the M_{d} (e.g., while freezing the weights of

$${M}_{e}^{R} )$$

considering the dataset D_{T} as the training set. As another example, NE can train M_{d} of the two-sided model of

$$( {M}_{e}^{R} , {M}_{d} )$$

using a dataset composed of combination of D_{T} and D_{NW}. The ratio between the samples coming from D_{T} and D_{NW} can be adjusted to ensure a match for samples observed during training and inference phases. This property reduces the possibility of mismatch between the trained M_{d} and Mₑ-Mₑ can be

$${M}_{e}^{R}$$

or a developed/used encoder model at the UE side, e.g., if the UE does not use

$${M}_{e}^{R}$$

directly and train its own encoder model based on the

$${M}_{e}^{R} .$$

In some examples, the NE may include at least a portion of D_{NW} in the training dataset for training M_{d} (e.g., an update to the decoder model based on only D_{T}) based on a degree of statistic/distribution mis-match/divergence between dataset D_{T} and D_{NW}.

In implementations, the UE can use the specified

$${M}_{e}^{R}$$

as the encoder model. Alternatively, or additionally, the UE can use another model Mₑ other than

$${M}_{e}^{R}$$

as the UE encoder and the UE can first train Mₑ. To train Mₑ, Options 1d(i) and 1d(ii) can be utilized. In Option 1d(i) a UE can use D_{UE}. For example, UE can consider

$${M}_{e}^{R}$$

as a teacher network, and use Mₑ as the student network and train the teacher-student network using the D_{UE}.

In Option 1d(ii), during the standardization process and at least for some reference encoder models, the reference encoder model is linked/associated to a training dataset D_{T} that is used for training the reference encoder in a specification. The linked/associated dataset, i.e., D_{T}, might be part of the actual training dataset or a dataset with samples having similar statistics of the actual training dataset, or combination of them. This training dataset can be specified in the specification or can be stored in a storage. The training dataset may become publicly accessible (e.g., to NE vendors and UE vendors) at a data storage location. To train Mₑ, a UE can use D_{T}. For example, the UE can consider

$${M}_{e}^{R}$$

as the teacher network and use Mₑ as a student network and train the teacher-student network using the D_{T}. Alternatively or additionally, the UE can train the teacher-student network using a dataset including a combination of D_{T} and D_{UE}. The ratio between the samples coming from D_{T} and D_{UE} can be adjusted to ensure that the trained Mₑ remains as close as possible to

$${M}_{e}^{R}$$

for both samples observed during training phase and also samples not observed during training phase. This property can reduce the possibility of mismatch between the trained Mₑ and M_{d}-M_{d} can be

$${M}_{d}^{R}$$

or a developed/used decoder model at the NE side. In some examples, the UE may include at least a portion of D_{UE} in the training dataset for training Mₑ (e.g., an update to the encoder model based on only D_{T}) based on a degree of statistic/distribution mismatch/divergence between dataset D_{T} and D_{UE}.

Alternatively, or additionally, instead of specifying

$${M}_{e}^{R} ,$$

a dataset representing the input and output of at least some of the trained reference encoders can be specified/stored. The UE can use this information to train the UE encoder model Mₑ. In such implementations, the NE side can use this dataset to train a local encoder model for the NE and use the trained encoder model to train the NE decoder M_{d}. In cases that xᵢ=yᵢ, the NE can respectively consider the input and output of the trained reference encoder as the expected output of the decoder model and the input of the decoder model, respectively, and train M_{d} using this dataset.

In Option 2d, the reference decoder

$${M}_{d}^{R}$$

can be specified in a standard specification. During inference, the NE side can have access to another dataset D_{NW}={(xᵢ, yᵢ), i={1, 2, . . . , N_{NW}}} and the UE side can have access to another dataset D_{UE}={(xᵢ, yᵢ), i={1, 2, . . . , N_{UE}}}, e.g., field data collection, model performance monitoring data, etc. In Option 2d, as

$${M}_{d}^{R}$$

specified in a specification, a UE can develop the encoder model Mₑ based on D_{UE} and assuming that the NE decoder may be implemented similarly to (compatible with)

$${M}_{d}^{R} .$$

Alternatively, or additionally during the standardization process, at least for some reference decoder models, the reference decoder model can be linked/associated to a training dataset D_{T} that is used for training the reference decoder in a specification. The linked/associated dataset, i.e., D_{T}, might be part of the actual training dataset or a dataset with samples having similar statistics of the actual training dataset, or combinations thereof. This training dataset can be specified in the specification or can be stored in a storage. The training dataset may become publicly accessible (at least to the NE vendors and UE vendors) at a data storage location. To train Mₑ, a UE can use D_{T}. For example, the UE can determine a two-sided model of

$$( {M}_{e} , {M}_{d}^{R} )$$

and train the Mₑ (while freezing the weights of

$${M}_{d}^{R} )$$

considering the dataset D_{T} as the training set. As another alternative or additional implementation, a UE can train Mₑ of the two-sided model of

$$( {M}_{e} , {M}_{d}^{R} )$$

using a dataset including a combination of D_{T} and D_{UE}. The ratio between the samples coming from D_{T} and D_{UE} can be adjusted to match samples observed during training and inference phase. This property can reduce the possibility of mismatch between the trained Mₑ and M_{d}, such as if the NE does not use

$${M}_{d}^{R}$$

directly and train its own encoder model based on the

$${M}_{d}^{R} .$$

In some examples, the UE may consider including at least a portion of D_{UE} in the training dataset for training Mₑ (e.g., an update to the encoder model based on only D_{T}) based on a degree of statistic/distribution mis-match/divergence between dataset D_{T} and D_{UE}.

In some implementations, the NE can use the specified

$${M}_{d}^{R}$$

as the encoder model. Alternatively or additionally, if the NE determines to use another model M_{d} other than

$${M}_{d}^{R} ,$$

as its decoder, the NE can first train M_{d}. To train M_{d}, in Option 2d(i) the NE can use D_{NW}. For example, the NE can use

$${M}_{d}^{R}$$

as the teacher network, and use M_{d} as the student network and train the teacher-student network using the D_{NW}. In Option 2d(ii), during the standardization process and at least for some reference encoder models, the reference encoder model can be linked/associated to a training dataset D_{T} that is used for training the reference encoder in a specification. The linked/associated dataset, i.e., D_{T}, might be part of the actual training dataset or a dataset with samples having similar statistics of the actual training dataset, or combinations thereof. This training dataset can be specified in the specification or can be stored in a storage. The training dataset may become publicly accessible (e.g., to the NE vendors and UE vendors) at a data storage location. To train M_{d}, an NE can use D_{T}. For example, the NE can determine

$${M}_{d}^{R}$$

as the teacher network, and then use M_{d} as the student network and train the teacher-student network using the D_{T}.

Alternatively, or additionally, the NE can train the teacher-student network using a dataset composed of combination of D_{T} and D_{NW}. The ratio between the samples coming from D_{T} and D_{NW} can be adjusted to ensure that the trained M_{d} remains as close as possible to

$${M}_{d}^{R}$$

for both samples observed during training phase and also samples not observed during training phase. This property reduces the possibility of mismatch between the trained M_{d} and generally, Mₑ-Mₑ can be

$${M}_{e}^{R}$$

or a developed/used encoder model at the UE side developed at the UE side. In some examples, the NE may consider including at least a portion of D_{NW} in the training dataset for training M_{d} (e.g., an update to the decoder model based on only D_{T}) based on a degree of statistic/distribution mis-match/divergence between dataset D_{T} and D_{NW}.

Alternatively, or additionally, instead of specifying

$${M}_{d}^{R} ,$$

a dataset representing the input and output (or expected output) of at least some of the trained reference decoders can be specified/stored. The NE can use this information to train its decoder model, M_{d}. In such implementations, the UE side can use this dataset to train a local decoder model for the UE and use the trained local decoder model to train its decoder, Mₑ. In cases that xᵢ=yᵢ, the UE can respectively consider the input and output (expected output) of the trained reference decoder as the expected output of the encoder model and the input of the encoder model, respectively, and train Mₑ using this dataset.

In Option 3d, both the reference encoder,

$${M}_{e}^{R} ,$$

and the reference decoder,

$${M}_{d}^{R} ,$$

can be specified in a specification. When both the reference decoder,

$${M}_{e}^{R} ,$$

and the reference decoder,

$${M}_{d}^{R}$$

are specified, the UE and network can use either of the options that was explained Option 1d and Option 2d to determine the encoder and decoder model.

In the discussed options, whenever both of the UE side and the NE side use their local dataset to train their respective encoder/decoder models, to reduce the possibility of mismatch the UE and NE sides can use combination of their respective datasets and D_{T}. Using D_{T} can assist UE side and NE side to be aligned while learning new information for the new datasets for each respective entity.

In Direction C, there can be more than one reference encoder/decoder model and therefore there can be multiple training dataset associated with multiple reference encoder/decoder models. Implementations can provide techniques (e.g., identifiers) to determine association between a dataset and a respective reference encoder/decoder.

Considering Direction B, during the training of the reference encoder model, the NE side can store the dataset D_{T-e} related to the encoder model, which can represent a dataset that was used for training of the reference encoder and/or set of samples representing the input and output of the reference encoder model. In this case, the NE side may have multiple reference encoder models and may use different training datasets for different reference encoder models. In such implementations, in cases where the UE side determines to update the encoder model using a UE local (inference) dataset, the UE can request from the NE a corresponding training dataset of the reference encoder and the UE can update the encoder model using both the UE local dataset and the corresponding D_{T-e}. In some implementations, the NE can send the training dataset to the UE without a request from the UE side, such as if the UE/NE determines that the initial encoder model is not achieving a threshold performance. In some implementations, the NE can send the training dataset to the UE concurrently with sending the information regarding the encoder itself. In some examples, the UE may include at least a portion of its local (inference) dataset training dataset for training Mₑ (e.g., an update to the encoder model based on D_{T-e}) based on a degree of statistic/distribution mis-match/divergence between dataset D_{T-e} and the UE local (inference) training dataset.

Considering Direction A, options are available where the NE sends information regarding a matching encoder model with UE vendors. The UE can use a matching encoder model directly and/or the UE can train a UE encoder model based on the received encoder model. In case the UE determines to train the encoder model, the UE can use the teacher-student procedure and train the encoder model with data samples that are collected at the UE during inference time. Updating the encoder model based on this dataset may result in mismatch between the UE encoder model and the NE decoder model since the NE decoder model may not have received data samples with UE side statistics. To mitigate such a mismatch, the NE side, while training for the matching encoder, can also store the dataset Dr-e related to the encoder model. The dataset D_{T-e}, for instance, can be a dataset that was used for training of the UE encoder model or set of samples representing the input and output of the encoder model.

In such cases, the NE side may have multiple reference encoder models and can maintain different training datasets for the different reference encoder models. Using the different training datasets, the NE can send D_{T-e} to the UE and the UE can train its encoder model using the combination of the dataset D_{T-e} and a set of data samples that are collected at the UE during inference time. In some examples, the UE may determine to include at least a portion of the set of data samples that are collected at the UE during the inference time for training Mₑ (e.g., an update to the encoder model based on D_{T-e}) based on a degree of statistic/distribution mis-match/divergence between dataset D_{T-e} and the set of samples that are collected at the UE during the inference time. As discussed herein the dataset Dr/D_{T-e} can be a dataset used for training of an encoder model, but the dataset D_{T}/D_{T-e} can also be set of data samples with equivalent statistics of the samples used for training of the model. The dataset D_{T}/D_{T-e} may not be exactly the samples used for training and can be a subset of samples used for training and can be combined with other data samples with similar statistics.

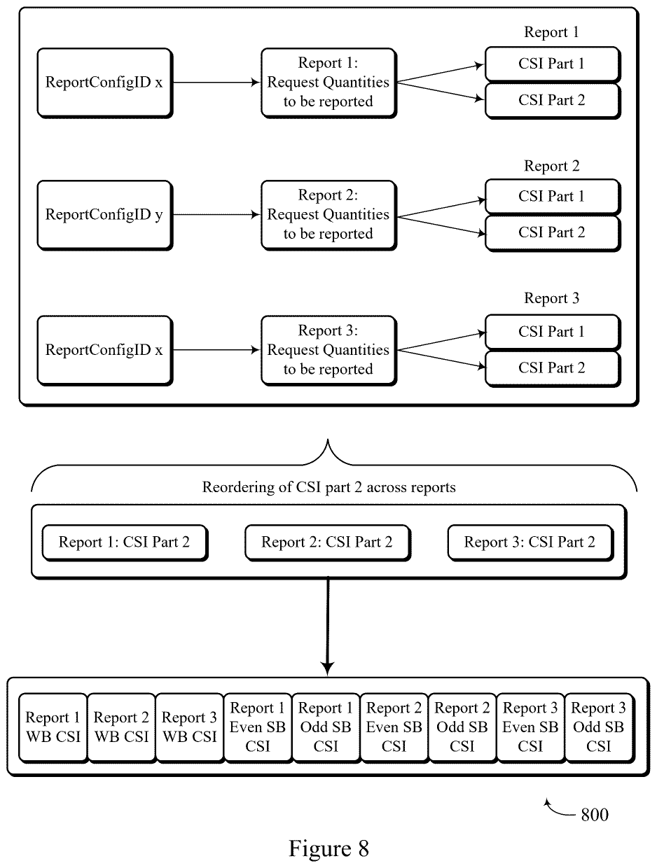

FIG. 9 illustrates an example of a UE 900 in accordance with aspects of the present disclosure. The UE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the UE 900 to perform various functions of the present disclosure.

The memory 904 may include volatile or non-volatile memory. The memory 904 may store computer-readable, computer-executable code including instructions when executed by the processor 902 cause the UE 900 to perform various functions described herein. The code may be stored in a non-transitory computer-readable medium such as the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the UE 900 to perform one or more of the functions described herein (e.g., executing, by the processor 902, instructions stored in the memory 904).

For example, the processor 902 may support wireless communication at the UE 900 in accordance with examples as disclosed herein. The UE 900 may be configured to or operable to support a means for obtaining a first neural network encoder model and a first data set associated with the first neural network encoder model; and communicating in accordance with a second neural network encoder model, where the second neural network encoder model is trained based at least in part on the first neural network encoder model and a second data set, where the second data set is based at least in part on the first data set.

Additionally, the UE 900 may be configured to support any one or combination of inputting a data sample to the trained second neural network encoder model to generate an encoded data sample, and communicating includes transmitting the encoded data sample to a second apparatus; obtaining the first neural network encoder model from a set of reference neural network encoder models; or retrieving the first neural network encoder model from a data storage; obtaining the first neural network encoder model from a second apparatus; or obtaining a parameter set for the first neural network encoder model from the second apparatus; the first data set includes one or more of: a set of data samples used to train the first neural network encoder model; or a set of data samples that are within a threshold statistical similarity to a set of data samples used to train the first neural network encoder model; obtaining the first data set from a set of reference training data sets; or retrieving the first data set from a data storage obtaining the first data set from a second apparatus; the second data set is based at least in part on a local training data set that is local to the UE, and where the local training data set includes one or more input data samples associated with one or more neural network encoder models; the local training data set is based at least in part on reference signals received from a second apparatus; determining a first portion of the second data set from the first data set and a second portion of the second data set from the local training data set based at least in part on a statistical similarity between the first data set and the local training data set; the second data set is based at least in part on a local training data set that is received from a second apparatus.

Additionally, or alternatively, the UE 900 may support at least one memory (e.g., the memory 904) and at least one processor (e.g., the processor 902) coupled with the at least one memory and configured to cause the UE to obtain a first neural network encoder model and a first data set associated with the first neural network encoder model; and communicate in accordance with a second neural network encoder model based at least in part on the first neural network encoder model and a second data set, where the second data set is based at least in part on the first data set.

Additionally, the UE 900 may be configured to support any one or combination of where the processor is configured to cause the UE to: input a data sample to the trained second neural network encoder model to generate an encoded data sample, where to communicate, the processor is configured to cause the UE to transmit the encoded data sample to a second apparatus; the processor is configured to cause the UE to: obtain the first neural network encoder model from a set of reference neural network encoder models; or retrieve the first neural network encoder model from a data storage; the processor is configured to cause the UE to: obtain the first neural network encoder model from a second apparatus; or obtain a parameter set for the first neural network encoder model from the second apparatus; the first data set includes one or more of: a set of data samples used to train the first neural network encoder model; or a set of data samples that are within a threshold statistical similarity to a set of data samples used to train the first neural network encoder model; the processor is configured to cause the UE to: obtain the first data set from a set of reference training data sets; or retrieve the first data set from a data storage; the processor is configured to cause the UE to obtain the first data set from a second apparatus; the second data set is based at least in part on a local training data set that is local to the UE, and where the local training data set includes one or more input data samples associated with one or more neural network encoder models; the local training data set is based at least in part on reference signals received from a second apparatus; the processor is configured to cause the UE to determine a first portion of the second data set from the first data set and a second portion of the second data set from the local training data set based at least in part on a statistical similarity between the first data set and the local training data set; the second data set is based at least in part on a local training data set that is received from a second apparatus.

For example, the processor 902 may support wireless communication at the UE 900 in accordance with examples as disclosed herein. The UE 900 may be configured to or operable to support a means for obtaining a first neural network decoder model and a first data set associated with the first neural network decoder model; and communicating in accordance with a second neural network decoder model, where the second neural network decoder model is trained based at least in part on the first neural network decoder model and a second data set, and where the second data set is determined based at least in part on the first data set.

Additionally, or alternatively, the UE 900 may support at least one memory (e.g., the memory 904) and at least one processor (e.g., the processor 902) coupled with the at least one memory and configured to cause the UE to obtain a first neural network decoder model and a first data set associated with the first neural network decoder model; and communicate in accordance with a second neural network decoder model, where the second neural network decoder model is trained based at least in part on the first neural network decoder model and a second data set, and where the second data set is determined based at least in part on the first data set.

For example, the processor 902 may support wireless communication at the UE 900 in accordance with examples as disclosed herein. The UE 900 may be configured to or operable to support a means for obtaining one or more of a first neural network encoder model or a first neural network decoder model, and one or more first data sets associated with one or more of the first neural network encoder model or the first neural network decoder model; and communicating in accordance with one or more of a second neural network encoder model or a second neural network decoder model, where the one or more of the second neural network encoder model or the second neural network decoder model are trained based at least in part on: the one or more of the first neural network encoder model or the first neural network decoder model; and one or more second data sets, where the one or more second data sets are determined based at least in part on the one or more first data sets.

Additionally, the UE 900 may be configured to support any one or combination of where the one or more of the first neural network encoder model, the first neural network decoder model, or the one or more first data sets are obtained from one or more of a set of reference neural network encoder models, a set of reference neural network decoder models, or a data storage; training the second neural network encoder model and the second neural network decoder model based at least in part on the first neural network encoder model, the first neural network decoder model, and the one or more second data sets; the one or more first data sets are obtained from one or more of a second apparatus or a data storage, and the one or more second data sets are based at least in part on a local training data set that is local to the UE, and where the local training data set includes one or more input data samples associated with one or more neural network encoder models; the local training data set is based at least in part on reference signals received at the UE from a second apparatus; determining a first portion of the one or more second data sets from the one or more first data sets and a second portion of one or more the second data sets from the local training data set based at least in part on a statistical similarity between the one or more first data sets and the local training data set.

Additionally, or alternatively, the UE 900 may support at least one memory (e.g., the memory 904) and at least one processor (e.g., the processor 902) coupled with the at least one memory and configured to cause the UE to obtain one or more of a first neural network encoder model or a first neural network decoder model, and one or more first data sets associated with one or more of the first neural network encoder model or the first neural network decoder model; and communicate in accordance with a second neural network encoder model, where the second neural network encoder model is trained based at least in part on the first neural network encoder model and a second data set, and where the second data set is determined based at least in part on the first data set.

Additionally, the UE 900 may be configured to support any one or combination of where the one or more of the first neural network encoder model, the first neural network decoder model, or the one or more first data sets are obtained from one or more of a set of reference neural network encoder models, a set of reference neural network decoder models, or a data storage; the processor is configured to cause the UE to train the second neural network encoder model and the second neural network decoder model based at least in part on the first neural network encoder model, the first neural network decoder model, and the one or more second data sets; the one or more first data sets are obtained from one or more of a second apparatus or a data storage, and the one or more second data sets are based at least in part on a local training data set that is local to the UE, and where the local training data set includes one or more input data samples associated with one or more neural network encoder models; the local training data set is based at least in part on reference signals received at the UE from a second apparatus; the processor is configured to cause the UE to determine a first portion of the one or more second data sets from the one or more first data sets and a second portion of one or more the second data sets from the local training data set based at least in part on a statistical similarity between the one or more first data sets and the local training data set

The controller 906 may manage input and output signals for the UE 900. The controller 906 may also manage peripherals not integrated into the UE 900. In some implementations, the controller 906 may utilize an operating system such as iOS®, ANDROID®, WINDOWS®, or other operating systems. In some implementations, the controller 906 may be implemented as part of the processor 902.

In some implementations, the UE 900 may include at least one transceiver 908. In some other implementations, the UE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas to receive a signal over the air or wireless medium. The receiver chain 910 may include at least one amplifier (e.g., a low-noise amplifier (LNA)) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

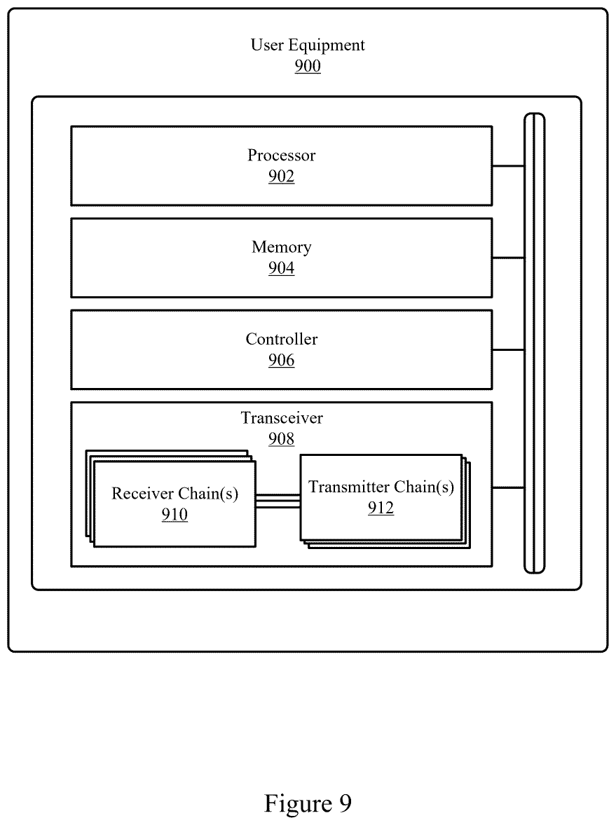

FIG. 10 illustrates an example of a processor 1000 in accordance with aspects of the present disclosure. The processor 1000 may be an example of a processor configured to perform various operations in accordance with examples as described herein. The processor 1000 may include a controller 1002 configured to perform various operations in accordance with examples as described herein. The processor 1000 may optionally include at least one memory 1004, which may be, for example, an L1/L2/L3 cache. Additionally, or alternatively, the processor 1000 may optionally include one or more arithmetic-logic units (ALUs) 1006. One or more of these components may be in electronic communication or otherwise coupled (e.g., operatively, communicatively, functionally, electronically, electrically) via one or more interfaces (e.g., buses).

The processor 1000 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1000) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1002 may be configured to manage and coordinate various operations (e.g., signaling, receiving, obtaining, retrieving, transmitting, outputting, forwarding, storing, determining, identifying, accessing, writing, reading) of the processor 1000 to cause the processor 1000 to support various operations in accordance with examples as described herein. For example, the controller 1002 may operate as a control unit of the processor 1000, generating control signals that manage the operation of various components of the processor 1000. These control signals include enabling or disabling functional units, selecting data paths, initiating memory access, and coordinating timing of operations.

The controller 1002 may be configured to fetch (e.g., obtain, retrieve, receive) instructions from the memory 1004 and determine subsequent instruction(s) to be executed to cause the processor 1000 to support various operations in accordance with examples as described herein. The controller 1002 may be configured to track memory addresses of instructions associated with the memory 1004. The controller 1002 may be configured to decode instructions to determine the operation to be performed and the operands involved. For example, the controller 1002 may be configured to interpret the instruction and determine control signals to be output to other components of the processor 1000 to cause the processor 1000 to support various operations in accordance with examples as described herein. Additionally, or alternatively, the controller 1002 may be configured to manage flow of data within the processor 1000. The controller 1002 may be configured to control transfer of data between registers, ALUs 1006, and other functional units of the processor 1000.

The memory 1004 may include one or more caches (e.g., memory local to or included in the processor 1000 or other memory, such as RAM, ROM, DRAM, SDRAM, SRAM, MRAM, flash memory, etc. In some implementations, the memory 1004 may reside within or on a processor chipset (e.g., local to the processor 1000). In some other implementations, the memory 1004 may reside external to the processor chipset (e.g., remote to the processor 1000).

The memory 1004 may store computer-readable, computer-executable code including instructions that, when executed by the processor 1000, cause the processor 1000 to perform various functions described herein. The code may be stored in a non-transitory computer-readable medium such as system memory or another type of memory. The controller 1002 and/or the processor 1000 may be configured to execute computer-readable instructions stored in the memory 1004 to cause the processor 1000 to perform various functions. For example, the processor 1000 and/or the controller 1002 may be coupled with or to the memory 1004, the processor 1000, and the controller 1002, and may be configured to perform various functions described herein. In some examples, the processor 1000 may include multiple processors and the memory 1004 may include multiple memories. One or more of the multiple processors may be coupled with one or more of the multiple memories, which may, individually or collectively, be configured to perform various functions herein.

The one or more ALUs 1006 may be configured to support various operations in accordance with examples as described herein. In some implementations, the one or more ALUs 1006 may reside within or on a processor chipset (e.g., the processor 1000). In some other implementations, the one or more ALUs 1006 may reside external to the processor chipset (e.g., the processor 1000). One or more ALUs 1006 may perform one or more computations such as addition, subtraction, multiplication, and division on data. For example, one or more ALUs 1006 may receive input operands and an operation code, which determines an operation to be executed. One or more ALUs 1006 may be configured with a variety of logical and arithmetic circuits, including adders, subtractors, shifters, and logic gates, to process and manipulate the data according to the operation. Additionally, or alternatively, the one or more ALUs 1006 may support logical operations such as AND, OR, exclusive-OR (XOR), not-OR (NOR), and not-AND (NAND), enabling the one or more ALUs 1006 to handle conditional operations, comparisons, and bitwise operations.

The processor 1000 may support wireless communication in accordance with examples as disclosed herein. The processor 1000 may be configured to or operable to support at least one controller (e.g., the controller 1002) coupled with at least one memory (e.g., the memory 1004) and configured to cause the processor to obtain a first neural network encoder model and a first data set associated with the first neural network encoder model; and communicate in accordance with a second neural network encoder model based at least in part on the first neural network encoder model and a second data set, where the second data set is based at least in part on the first data set.

Additionally, the processor 1000 may be configured to or operable to support any one or combination of where the controller is configured to cause the processor to: input a data sample to the trained second neural network encoder model to generate an encoded data sample, where to communicate, the controller is configured to cause the processor to transmit the encoded data sample to a second apparatus; the controller is configured to cause the processor to: obtain the first neural network encoder model from a set of reference neural network encoder models; or retrieve the first neural network encoder model from a data storage; the controller is configured to cause the processor to: obtain the first neural network encoder model from a second apparatus; or obtain a parameter set for the first neural network encoder model from the second apparatus; the first data set includes one or more of: a set of data samples used to train the first neural network encoder model; or a set of data samples that are within a threshold statistical similarity to a set of data samples used to train the first neural network encoder model; the controller is configured to cause the processor to: obtain the first data set from a set of reference training data sets; or retrieve the first data set from a data storage; the controller is configured to cause the processor to obtain the first data set from a second apparatus; the second data set is based at least in part on a local training data set that is local to the processor, and where the local training data set includes one or more input data samples associated with one or more neural network encoder models; the local training data set is based at least in part on reference signals received from a second apparatus; the controller is configured to cause the processor to determine a first portion of the second data set from the first data set and a second portion of the second data set from the local training data set based at least in part on a statistical similarity between the first data set and the local training data set; the second data set is based at least in part on a local training data set that is received from a second apparatus.

The processor 1000 may support wireless communication in accordance with examples as disclosed herein. The processor 1000 may be configured to or operable to support at least one controller (e.g., the controller 1002) coupled with at least one memory (e.g., the memory 1004) and configured to cause the processor to obtain a first neural network decoder model and a first data set associated with the first neural network decoder model; and communicate in accordance with a second neural network decoder model, where the second neural network decoder model is trained based at least in part on the first neural network decoder model and a second data set, and where the second data set is determined based at least in part on the first data set.

The processor 1000 may support wireless communication in accordance with examples as disclosed herein. The processor 1000 may be configured to or operable to support at least one controller (e.g., the controller 1002) coupled with at least one memory (e.g., the memory 1004) and configured to cause the processor to obtain one or more of a first neural network encoder model or a first neural network decoder model, and one or more first data sets associated with one or more of the first neural network encoder model or the first neural network decoder model; and communicate in accordance with one or more of a second neural network encoder model or a second neural network decoder model, where the one or more of the second neural network encoder model or the second neural network decoder model are trained based at least in part on: the one or more of the first neural network encoder model or the first neural network decoder model; and one or more second data sets, where the one or more second data sets are determined based at least in part on the one or more first data sets.

Additionally, the processor 1000 may be configured to or operable to support any one or combination of where the one or more of the first neural network encoder model, the first neural network decoder model, or the one or more first data sets are obtained from one or more of a set of reference neural network encoder models, a set of reference neural network decoder models, or a data storage; the controller is configured to cause the processor to train the second neural network encoder model and the second neural network decoder model based at least in part on the first neural network encoder model, the first neural network decoder model, and the one or more second data sets; the one or more first data sets are obtained from one or more of a second apparatus or a data storage, and the one or more second data sets are based at least in part on a local training data set that is local to the processor, and where the local training data set includes one or more input data samples associated with one or more neural network encoder models; the local training data set is based at least in part on reference signals received at the processor from a second apparatus; the controller is configured to cause the processor to determine a first portion of the one or more second data sets from the one or more first data sets and a second portion of one or more the second data sets from the local training data set based at least in part on a statistical similarity between the one or more first data sets and the local training data set.

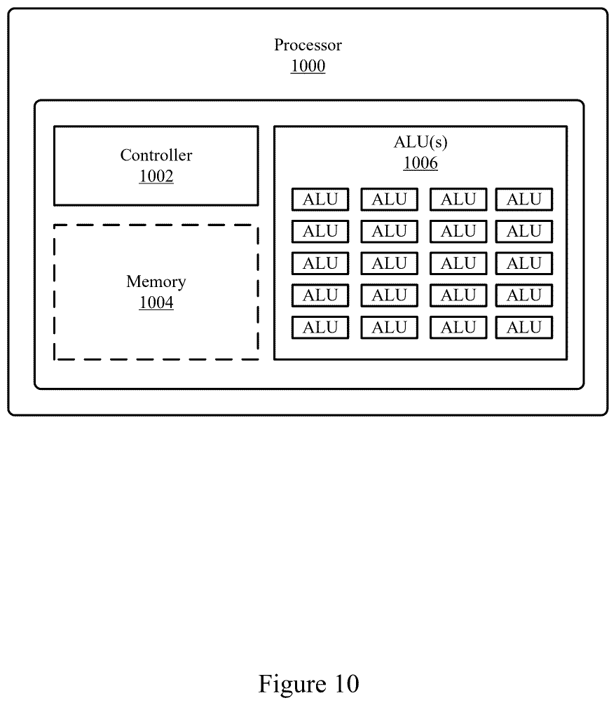

FIG. 11 illustrates an example of a NE 1100 in accordance with aspects of the present disclosure. The NE 1100 may include a processor 1102, a memory 1104, a controller 1106, and a transceiver 1108. The processor 1102, the memory 1104, the controller 1106, or the transceiver 1108, or various combinations thereof or various components thereof may be examples of means for performing various aspects of the present disclosure as described herein. These components may be coupled (e.g., operatively, communicatively, functionally, electronically, electrically) via one or more interfaces.

The processor 1102, the memory 1104, the controller 1106, or the transceiver 1108, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1102 may include an intelligent hardware device (e.g., a general-purpose processor, a DSP, a CPU, an ASIC, an FPGA, or any combination thereof). In some implementations, the processor 1102 may be configured to operate the memory 1104. In some other implementations, the memory 1104 may be integrated into the processor 1102. The processor 1102 may be configured to execute computer-readable instructions stored in the memory 1104 to cause the NE 1100 to perform various functions of the present disclosure.

The memory 1104 may include volatile or non-volatile memory. The memory 1104 may store computer-readable, computer-executable code including instructions when executed by the processor 1102 cause the NE 1100 to perform various functions described herein. The code may be stored in a non-transitory computer-readable medium such as the memory 1104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1102 and the memory 1104 coupled with the processor 1102 may be configured to cause the NE 1100 to perform one or more of the functions described herein (e.g., executing, by the processor 1102, instructions stored in the memory 1104). For example, the processor 1102 may support wireless communication at the NE 1100 in accordance with examples as disclosed herein. The NE 1100 may be configured to or operable to support a means for obtaining a first neural network encoder model and a first data set associated with the first neural network encoder model; and communicating in accordance with a second neural network encoder model based at least in part on the first neural network encoder model and a second data set, where the second data set is based at least in part on the first data set.

Additionally, the NE 1100 may be configured to or operable to support any one or combination of inputting a data sample to the trained second neural network encoder model to generate an encoded data sample, and transmitting the encoded data sample to a second apparatus; obtaining the first neural network encoder model from a set of reference neural network encoder models; or retrieving the first neural network encoder model from a data storage; obtaining the first neural network encoder model from a second apparatus; or obtaining a parameter set for the first neural network encoder model from the second apparatus; the first data set includes one or more of: a set of data samples used to train the first neural network encoder model; or a set of data samples that are within a threshold statistical similarity to a set of data samples used to train the first neural network encoder model; obtaining the first data set from a set of reference training data sets; or retrieving the first data set from a data storage; obtaining the first data set from a second apparatus; the second data set is based at least in part on a local training data set that is local to the NE, and where the local training data set includes one or more input data samples associated with one or more neural network encoder models; the local training data set is based at least in part on reference signals received from a second apparatus; determining a first portion of the second data set from the first data set and a second portion of the second data set from the local training data set based at least in part on a statistical similarity between the first data set and the local training data set; the second data set is based at least in part on a local training data set that is received from a second apparatus.

Additionally, or alternatively, the NE 1100 may support at least one memory (e.g., the memory 1104) and at least one processor (e.g., the processor 1102) coupled with the at least one memory and configured to cause the NE to obtain a first neural network encoder model and a first data set associated with the first neural network encoder model; and communicate in accordance with a second neural network encoder model based at least in part on the first neural network encoder model and a second data set, where the second data set is based at least in part on the first data set.

Additionally, the NE 1100 may be configured to support any one or combination of where the processor is configured to cause the NE to: input a data sample to the trained second neural network encoder model to generate an encoded data sample, where to communicate, the processor is configured to cause the NE to transmit the encoded data sample to a second apparatus; the processor is configured to cause NE to: obtain the first neural network encoder model from a set of reference neural network encoder models; or retrieve the first neural network encoder model from a data storage; the processor is configured to cause the NE to: obtain the first neural network encoder model from a second apparatus; or obtain a parameter set for the first neural network encoder model from the second apparatus; the first data set includes one or more of: a set of data samples used to train the first neural network encoder model; or a set of data samples that are within a threshold statistical similarity to a set of data samples used to train the first neural network encoder model; the processor is configured to cause the NE to: obtain the first data set from a set of reference training data sets; or retrieve the first data set from a data storage; the processor is configured to cause the NE to obtain the first data set from a second apparatus; the second data set is based at least in part on a local training data set that is local to the NE, and where the local training data set includes one or more input data samples associated with one or more neural network encoder models; the local training data set is based at least in part on reference signals received from a second apparatus; the processor is configured to cause the NE to determine a first portion of the second data set from the first data set and a second portion of the second data set from the local training data set based at least in part on a statistical similarity between the first data set and the local training data set; the second data set is based at least in part on a local training data set that is received from a second apparatus.

For example, the processor 1102 may support wireless communication at the NE 1100 in accordance with examples as disclosed herein. The NE 1100 may be configured to or operable to support a means for obtaining a first neural network decoder model and a first data set associated with the first neural network decoder model; and communicating in accordance with a second neural network decoder model, where the second neural network decoder model is trained based at least in part on the first neural network decoder model and a second data set, and where the second data set is determined based at least in part on the first data set.

Additionally, or alternatively, the NE 1100 may support at least one memory (e.g., the memory 1104) and at least one processor (e.g., the processor 1102) coupled with the at least one memory and configured to cause the NE to obtain a first neural network decoder model and a first data set associated with the first neural network decoder model; and communicate in accordance with a second neural network decoder model, where the second neural network decoder model is trained based at least in part on the first neural network decoder model and a second data set, and where the second data set is determined based at least in part on the first data set.

For example, the processor 1102 may support wireless communication at the NE 1100 in accordance with examples as disclosed herein. The NE 1100 may be configured to or operable to support a means for obtaining one or more of a first neural network encoder model or a first neural network decoder model, and one or more first data sets associated with one or more of the first neural network encoder model or the first neural network decoder model; and communicating in accordance with one or more of a second neural network encoder model or a second neural network decoder model, where the one or more of the second neural network encoder model or the second neural network decoder model are trained based at least in part on: the one or more of the first neural network encoder model or the first neural network decoder model; and one or more second data sets, where the one or more second data sets are determined based at least in part on the one or more first data sets.

Additionally, the NE 1100 may be configured to or operable to support any one or combination of where the one or more of the first neural network encoder model, the first neural network decoder model, or the one or more first data sets are obtained from one or more of a set of reference neural network encoder models, a set of reference neural network decoder models, or a data storage; training the second neural network encoder model and the second neural network decoder model based at least in part on the first neural network encoder model, the first neural network decoder model, and the one or more second data sets; the one or more first data sets are obtained from one or more of a second apparatus or a data storage, and the one or more second data sets are based at least in part on a local training data set that is local to the NE, and where the local training data set includes one or more input data samples associated with one or more neural network encoder models; the local training data set is based at least in part on reference signals received at the NE from a second apparatus; determining a first portion of the one or more second data sets from the one or more first data sets and a second portion of one or more the second data sets from the local training data set based at least in part on a statistical similarity between the one or more first data sets and the local training data set.

Additionally, or alternatively, the NE 1100 may support at least one memory (e.g., the memory 1104) and at least one processor (e.g., the processor 1102) coupled with the at least one memory and configured to cause the NE to obtain one or more of a first neural network encoder model or a first neural network decoder model, and one or more first data sets associated with one or more of the first neural network encoder model or the first neural network decoder model; and communicate in accordance with one or more of a second neural network encoder model or a second neural network decoder model, where the one or more of the second neural network encoder model or the second neural network decoder model are trained based at least in part on: the one or more of the first neural network encoder model or the first neural network decoder model; and one or more second data sets, where the one or more second data sets are determined based at least in part on the one or more first data sets.

Additionally, the NE 1100 may be configured to support any one or combination of where the one or more of the first neural network encoder model, the first neural network decoder model, or the one or more first data sets are obtained from one or more of a set of reference neural network encoder models, a set of reference neural network decoder models, or a data storage; the processor is configured to cause the NE to train the second neural network encoder model and the second neural network decoder model based at least in part on the first neural network encoder model, the first neural network decoder model, and the one or more second data sets; the one or more first data sets are obtained from one or more of a second apparatus or a data storage, and the one or more second data sets are based at least in part on a local training data set that is local to the NE, and where the local training data set includes one or more input data samples associated with one or more neural network encoder models; the local training data set is based at least in part on reference signals received at the NE from a second apparatus; the processor is configured to cause the NE to determine a first portion of the one or more second data sets from the one or more first data sets and a second portion of one or more the second data sets from the local training data set based at least in part on a statistical similarity between the one or more first data sets and the local training data set.

The controller 1106 may manage input and output signals for the NE 1100. The controller 1106 may also manage peripherals not integrated into the NE 1100. In some implementations, the controller 1106 may utilize an operating system such as iOS®, ANDROID®, WINDOWS®, or other operating systems. In some implementations, the controller 1106 may be implemented as part of the processor 1102.

In some implementations, the NE 1100 may include at least one transceiver 1108. In some other implementations, the NE 1100 may have more than one transceiver 1108. The transceiver 1108 may represent a wireless transceiver. The transceiver 1108 may include one or more receiver chains 1110, one or more transmitter chains 1112, or a combination thereof.

A receiver chain 1110 may be configured to receive signals (e.g., control information, data, packets) over a wireless medium. For example, the receiver chain 1110 may include one or more antennas to receive a signal over the air or wireless medium. The receiver chain 1110 may include at least one amplifier (e.g., LNA) configured to amplify the received signal. The receiver chain 1110 may include at least one demodulator configured to demodulate the receive signal and obtain the transmitted data by reversing the modulation technique applied during transmission of the signal. The receiver chain 1110 may include at least one decoder for decoding the demodulated signal to receive the transmitted data.

A transmitter chain 1112 may be configured to generate and transmit signals (e.g., control information, data, packets). The transmitter chain 1112 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like PSK or QAM. The transmitter chain 1112 may also include at least one power amplifier configured to amplify the modulated signal to an appropriate power level suitable for transmission over the wireless medium. The transmitter chain 1112 may also include one or more antennas for transmitting the amplified signal into the air or wireless medium.

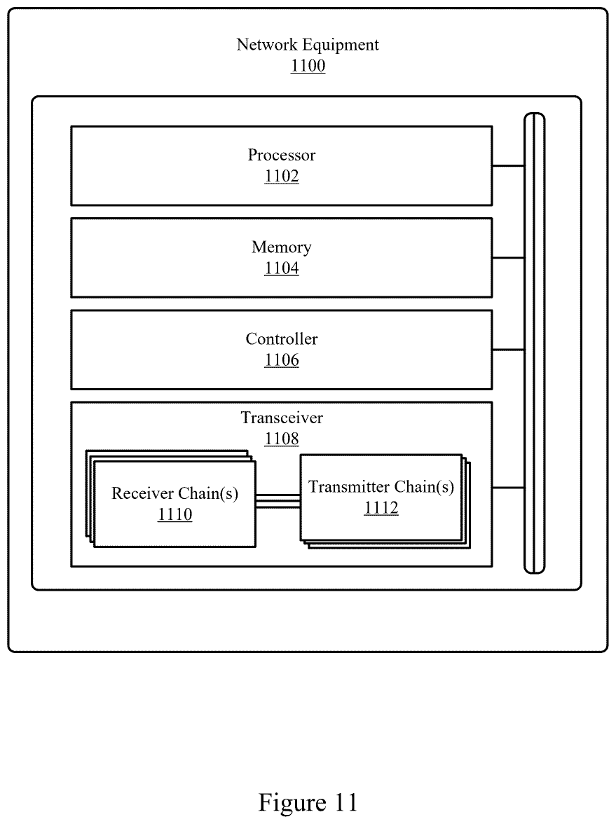

FIG. 12 illustrates a flowchart of a method 1200 in accordance with aspects of the present disclosure. The operations of the method may be implemented by a UE, an NE, and/or a processor as described herein. In some implementations, the UE, processor, and/or NE may execute a set of instructions to control the function elements of the UE, processor, and/or NE to perform the described functions. It should be noted that the method described herein describes a possible implementation, and that the operations and the steps may be rearranged or otherwise modified and that other implementations are possible.

At 1202, the method may include obtaining a first neural network encoder model and a first data set associated with the first neural network encoder model. The operations of 1202 may be performed in accordance with examples as described herein. In some implementations, aspects of the operations of 1202 may be performed by a UE as described with reference to FIG. 9, a processor as described with reference to FIG. 10, and/or an NE as described with reference to FIG. 11.

At 1204, the method may include communicating in accordance with a second neural network encoder model, where the second neural network encoder model is trained based at least in part on the first neural network encoder model and a second data set, and where the second data set is determined based at least in part on the first data set. The operations of 1204 may be performed in accordance with examples as described herein. In some implementations, aspects of the operations of 1204 may be performed by a UE as described with reference to FIG. 9, a processor as described with reference to FIG. 10, and/or an NE as described with reference to FIG. 11.

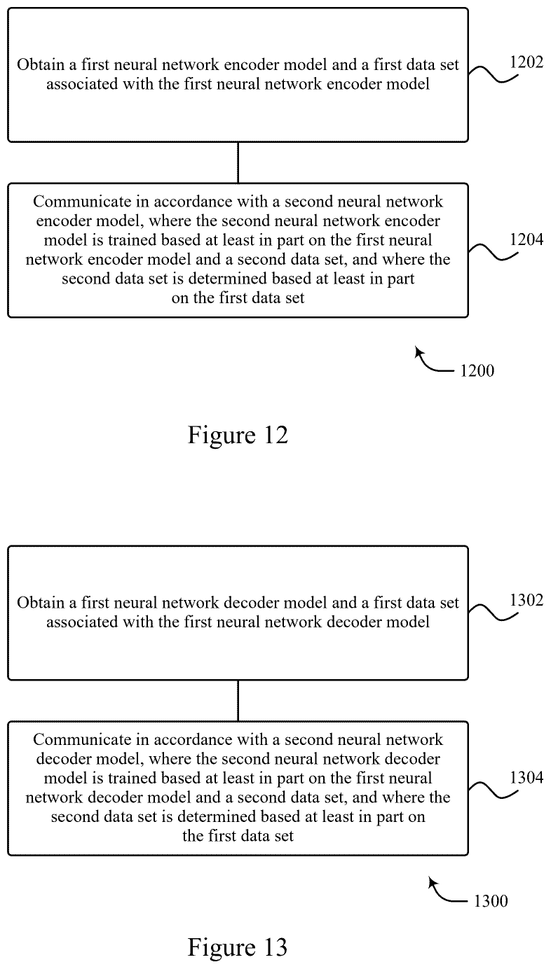

FIG. 13 illustrates a flowchart of a method 1300 in accordance with aspects of the present disclosure. The operations of the method may be implemented by a UE, an NE, and/or a processor as described herein. In some implementations, the UE, processor, and/or NE may execute a set of instructions to control the function elements of the UE, processor, and/or NE to perform the described functions. It should be noted that the method described herein describes a possible implementation, and that the operations and the steps may be rearranged or otherwise modified and that other implementations are possible.

At 1302, the method may include obtaining a first neural network decoder model and a first data set associated with the first neural network decoder model. The operations of 1302 may be performed in accordance with examples as described herein. In some implementations, aspects of the operations of 1302 may be performed by a UE as described with reference to FIG. 9, a processor as described with reference to FIG. 10, and/or an NE as described with reference to FIG. 11.

At 1304, the method may include communicating in accordance with a second neural network decoder model, where the second neural network decoder model is trained based at least in part on the first neural network decoder model and a second data set, and where the second data set is determined based at least in part on the first data set. The operations of 1304 may be performed in accordance with examples as described herein. In some implementations, aspects of the operations of 1304 may be performed by a UE as described with reference to FIG. 9, a processor as described with reference to FIG. 10, and/or an NE as described with reference to FIG. 11.

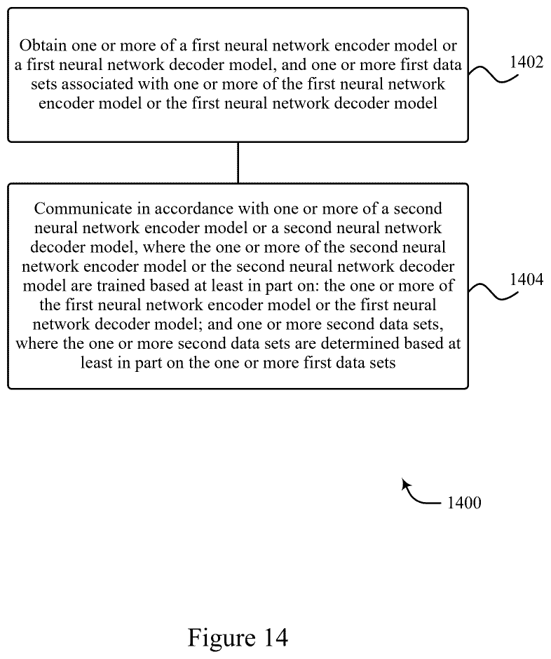

FIG. 14 illustrates a flowchart of a method 1400 in accordance with aspects of the present disclosure. The operations of the method may be implemented by a UE, an NE, and/or a processor as described herein. In some implementations, the UE, processor, and/or NE may execute a set of instructions to control the function elements of the UE, processor, and/or NE to perform the described functions. It should be noted that the method described herein describes a possible implementation, and that the operations and the steps may be rearranged or otherwise modified and that other implementations are possible.

At 1402, the method may include obtaining one or more of a first neural network encoder model or a first neural network decoder model, and one or more first data sets associated with one or more of the first neural network encoder model or the first neural network decoder model. The operations of 1402 may be performed in accordance with examples as described herein. In some implementations, aspects of the operations of 1402 may be performed by a UE as described with reference to FIG. 9, a processor as described with reference to FIG. 10, and/or an NE as described with reference to FIG. 11.

At 1404, the method may include communicating in accordance with one or more of a second neural network encoder model or a second neural network decoder model, where the one or more of the second neural network encoder model or the second neural network decoder model are trained based at least in part on: the one or more of the first neural network encoder model or the first neural network decoder model; and one or more second data sets, where the one or more second data sets are determined based at least in part on the one or more first data sets. The operations of 1404 may be performed in accordance with examples as described herein. In some implementations, aspects of the operations of 1404 may be performed by a UE as described with reference to FIG. 9, a processor as described with reference to FIG. 10, and/or an NE as described with reference to FIG. 11.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first apparatus for wireless communication, comprising:
at least one memory; and
at least one processor coupled with the at least one memory and configured to cause the first apparatus to:
obtain a first neural network encoder model and a first data set associated with the first neural network encoder model; and
communicate in accordance with a second neural network encoder model, wherein the second neural network encoder model is trained based at least in part on the first neural network encoder model and a second data set, and wherein the second data set is determined based at least in part on the first data set.

2. The first apparatus of claim 1, wherein the at least one processor is configured to cause the first apparatus to:
input a data sample to the trained second neural network encoder model to generate an encoded data sample, wherein to communicate, the at least one processor is configured to cause the first apparatus to transmit the encoded data sample to a second apparatus.

3. The first apparatus of claim 1, wherein the at least one processor is configured to cause the first apparatus to:
obtain the first neural network encoder model from a set of reference neural network encoder models; or
retrieve the first neural network encoder model from a data storage.

4. The first apparatus of claim 1, wherein the at least one processor is configured to cause the first apparatus to:
obtain the first neural network encoder model from a second apparatus; or
obtain a parameter set for the first neural network encoder model from the second apparatus.

5. The first apparatus of claim 1, wherein the first data set comprises one or more of:
a set of data samples used to train the first neural network encoder model; or
a set of data samples that are within a threshold statistical similarity to a set of data samples used to train the first neural network encoder model.

6. The first apparatus of claim 1, wherein the at least one processor is configured to cause the first apparatus to:
obtain the first data set from a set of reference training data sets; or
retrieve the first data set from a data storage.

7. The first apparatus of claim 1, wherein the at least one processor is configured to cause the first apparatus to obtain the first data set from a second apparatus.

8. The first apparatus of claim 1, wherein the second data set is based at least in part on a local training data set that is local to the first apparatus, and wherein the local training data set comprises one or more input data samples associated with one or more neural network encoder models.

9. The first apparatus of claim 8, wherein the local training data set is based at least in part on reference signals received from a second apparatus.

10. The first apparatus of claim 8, wherein the at least one processor is configured to cause the first apparatus to determine a first portion of the second data set from the first data set and a second portion of the second data set from the local training data set based at least in part on a statistical similarity between the first data set and the local training data set.

11. The first apparatus of claim 1, wherein the second data set is based at least in part on a local training data set that is received from a second apparatus.

12. The first apparatus of claim 1, wherein the first apparatus comprises a user equipment (UE) or a network equipment (NE).

13. A first apparatus for wireless communication, comprising:
at least one memory; and
at least one processor coupled with the at least one memory and configured to cause the first apparatus to:
obtain a first neural network decoder model and a first data set associated with the first neural network decoder model; and
communicate in accordance with a second neural network decoder model, wherein the second neural network decoder model is trained based at least in part on the first neural network decoder model and a second data set, and wherein the second data set is determined based at least in part on the first data set.

14. A first apparatus for wireless communication, comprising:
at least one memory; and
at least one processor coupled with the at least one memory and configured to cause the first apparatus to:
obtain one or more of a first neural network encoder model or a first neural network decoder model, and one or more first data sets associated with one or more of the first neural network encoder model or the first neural network decoder model; and
communicate in accordance with one or more of a second neural network encoder model or a second neural network decoder model, wherein the one or more of the second neural network encoder model or the second neural network decoder model are trained based at least in part on:
the one or more of the first neural network encoder model or the first neural network decoder model; and
one or more second data sets, wherein the one or more second data sets are determined based at least in part on the one or more first data sets.

15. The first apparatus of claim 14, wherein the one or more of the first neural network encoder model, the first neural network decoder model, or the one or more first data sets are obtained from one or more of a set of reference neural network encoder models, a set of reference neural network decoder models, or a data storage.

16. The first apparatus of claim 14, wherein the at least one processor is configured to cause the first apparatus to train the second neural network encoder model and the second neural network decoder model based at least in part on the first neural network encoder model, the first neural network decoder model, and the one or more second data sets.

17. The first apparatus of claim 14, wherein the one or more first data sets are obtained from one or more of a second apparatus or a data storage, and the one or more second data sets are based at least in part on a local training data set that is local to the first apparatus, and wherein the local training data set comprises one or more input data samples associated with one or more neural network encoder models.

18. The first apparatus of claim 17, wherein the local training data set is based at least in part on reference signals received at the first apparatus from a second apparatus.

19. The first apparatus of claim 17, wherein the at least one processor is configured to cause the first apparatus to determine a first portion of the one or more second data sets from the one or more first data sets and a second portion of one or more the second data sets from the local training data set based at least in part on a statistical similarity between the one or more first data sets and the local training data set.

20. A processor for wireless communication, comprising:
at least one controller coupled with at least one memory and configured to cause the processor to:
obtain one or more of a first neural network encoder model or a first neural network decoder model, and one or more first data sets associated with one or more of the first neural network encoder model or the first neural network decoder model; and
communicate in accordance with one or more of a second neural network encoder model or a second neural network decoder model, wherein the one or more of the second neural network encoder model or the second neural network decoder model are trained based at least in part on:
the one or more of the first neural network encoder model or the first neural network decoder model; and
one or more second data sets, wherein the one or more second data sets are determined based at least in part on the one or more first data sets.
